(19) United States
(12) Patent Application Publication
(10) Pub. No.: US 2015/0259218 A1
(43) Pub. Date: Sep. 17, 2015

(54) FILTRATION UNITS, FILTRATION SYSTEMS, AND FILTRATION METHODS

(71) Applicant: Aquasana, Inc., Austin, TX (US)

(72) Inventors: Erdogan Ergican, Austin, TX (US); Mukul Anil Khairatkar, Austin, TX (US); Sann Myint Naing, Austin, TX (US); Wes Russell, Bridgeport, TX (US); James T. McGee, Chelsea, MA (US); Paul K. Metaxatos, Swampscott, MA (US); Joel F. Nevin, Portsmouth, NH (US); Nicholas Varjabedian, Austin, TX (US)

(21) Appl. No.: 14/214,534

(22) Filed: Mar. 14, 2014

(51) Int. Cl. C02F 1/00; B01F 3/04

(52) U.S. Cl. CPC C02F 1/003; B01F 3/04099

(57) ABSTRACT

The present invention relates generally to fluid filtration, such as, for example, filtration systems and units (and components thereof) and filtration methods.

### BACKGROUND

1. Field of the Invention

The present invention relates generally to fluid filtration, and more particularly, but not by way of limitation, to filtration systems and units (and components thereof) and filtration methods.

2. Description of Related Art

Examples of filtration systems are disclosed in U.S. Pat. Nos. 5,296,148; 5,643,444; and 6,361,686, U.S. Patent Publication Nos. 2006/0163174 and 2007/0209984, and WO/2013/173242.

### SUMMARY

This disclosure includes embodiments of filtration systems and units (and components thereof) and filtration methods.

Some embodiments of the present filtration units comprise a pump; a carbonator; and a housing coupled to the pump and the carbonator, the housing configured to be coupled to: a filter; a carbonation canister; and a pitcher; where, if the housing is coupled to a filter, a carbonation canister comprising fluid, and a pitcher comprising fluid, the filtration unit can: pump fluid from the pitcher, through the filter, and out of the housing if a user activates a first configuration; and pump fluid from the pitcher, through the filter, through the carbonator to be mixed with fluid from the carbonation canister, and out of the housing if a user activates a second configuration. In some embodiments, the housing further comprises a dry break assembly configured to cooperate with a pitcher to permit fluid communication between an interior of a pitcher and the filtration unit. In some embodiments, if the housing is coupled to a pitcher, the pitcher and the filtration unit cooperate to permit fluid communication between an interior of the pitcher and the filtration unit. In some embodiments, the pitcher comprises a valve and the filtration unit comprises a dry break assembly, and the dry break assembly is configured to cooperate with the valve to permit fluid communication between an interior of the pitcher and the filtration unit. Some embodiments further comprise a controller configured to enable a user to activate the first configuration if a user presses a first button and to enable a user to activate the second configuration if a user presses a second button. Some embodiments further comprise a controller; and a sensor coupled to the controller and configured to detect if fluid enters the filtration unit; where, if a user activates the first configuration or the second configuration, the controller is configured to pump fluid from a pitcher after the sensor detects that fluid has entered the filtration unit. Some embodiments further comprise a controller; a first solenoid; a second solenoid; and a third solenoid; where the controller is configured such that: if a user activates the first configuration, the controller signals to open the first solenoid to permit fluid from the pitcher to move out of the housing; and if a user activates the second configuration, the controller signals to: open the second solenoid to permit fluid from the pitcher to move into the carbonator; and open the third solenoid to permit fluid from the carbonation canister to move into the carbonator. Some embodiments further comprise a flow conditioner configured to control fluid flow after exiting the carbonator, to control fluid pressure after exiting the carbonator, and/or to control fluid mixing after exiting the carbonator. In some embodiments, the filtration unit is configured such that fluid flow is approximately 60 pounds per square inch before exiting the housing. In some embodiments, the flow conditioner maintains the fluid pressure at approximately 60 pounds per square inch. In some embodiments, if the housing is coupled to a pitcher, the pitcher is configured to be coupled to a cooling stick (which may also be characterized as a cooling cartridge or cooling insert) configured to cool fluid in the pitcher. Some embodiments further comprise a carbonation canister adjuster configured to permit a user to adjust an amount of fluid exiting the carbonation canister if a carbonation canister is coupled to the housing. Some embodiments of the present carbonation canister adjusters may be characterized as configured to allow fine tuning of carbonation. In some embodiments, if a filter is coupled to the housing, the filtration unit is configured to alert a user when the filter should be replaced. Some embodiments further comprise a carbonation canister compartment configured to accommodate a carbonation canister; and a door configured to open to permit a user to couple a carbonation canister to or decouple a carbonation canister from the housing and configured to close to prevent visibility of the carbonation canister.

Some embodiments of the present carbonation canister adjusters may be characterized as configured to allow fine tuning of carbonation.

Some embodiments of the present filtration units comprise a pump; a carbonator; and a housing coupled to the pump and the carbonator, the housing configured to be coupled to: a filter; a carbonation canister; and a pitcher; where, if the housing is coupled to a filter, a carbonation canister comprising fluid, and a pitcher comprising fluid, the filtration unit can: filter fluid from the pitcher and dispense the fluid from the housing if a user activates a first configuration; and filter fluid from the pitcher, mix fluid from the pitcher with fluid from the carbonation canister, and dispense fluid from the housing if a user activates a second configuration. In some embodiments, the housing further comprises a dry break assembly configured to cooperate with a pitcher to permit fluid communication between an interior of a pitcher and the filtration unit. In some embodiments, if the housing is coupled to a pitcher, the pitcher and the filtration unit cooperate to permit fluid communication between an interior of the pitcher and the filtration unit. In some embodiments, the pitcher comprises a valve and the filtration unit comprises a dry break assembly, and the dry break assembly is configured to cooperate with the valve to permit fluid communication between an interior of the pitcher and the filtration unit. Some embodiments further comprise a controller configured to enable a user to activate the first configuration if a user presses a first button and to enable a user to activate the second configuration if a user presses a second button. Some embodiments further comprise a controller; and a sensor coupled to the controller and configured to detect if fluid enters the filtration unit; where, if a user activates the first configuration or the second configuration, the controller is configured to pump fluid from a pitcher after the sensor detects that fluid has entered the filtration unit. Some embodiments further comprise a controller; a first solenoid; a second solenoid; and a third solenoid; where the controller is configured such that: if a user activates the first configuration, the controller signals to open the first solenoid to permit fluid from the pitcher to move out of the housing; and if a user activates the second configuration, the controller signals to: open the second solenoid to permit fluid from the pitcher to move into the carbonator; and open the third solenoid to permit fluid from the carbonation canister to move into the carbonator. Some embodiments further comprise a flow conditioner configured to control fluid flow after exiting the carbonator, to control fluid pressure after exiting the carbonator, and/or to control fluid mixing after exiting the carbonator. In some embodiments, the filtration unit is configured such that fluid flow is approximately 60 pounds per square inch before exiting the housing. In some embodiments, the flow conditioner maintains the fluid pressure at approximately 60 pounds per square inch. In some embodiments, if the housing is coupled to a pitcher, the pitcher is configured to be coupled to a cooling stick configured to cool fluid in the pitcher. Some embodiments further comprise a carbonation canister adjuster configured to permit a user to adjust an amount of fluid exiting the carbonation canister if a carbonation canister is coupled to the housing. In some embodiments, if a filter is coupled to the housing, the filtration unit is configured to alert a user when the filter should be replaced. In some embodiments, the housing further comprises: a carbonation canister compartment configured to accommodate a carbonation canister; and a door configured to open to permit a user to couple a carbonation canister to or decouple a carbonation canister from the housing and configured to close to prevent visibility of the carbonation canister.

Some embodiments of the present systems comprise a pitcher; a filter; a carbonation canister; and a filtration unit coupled to the pitcher, the filter, and the carbonation canister, the filtration unit comprising: a pump; and a carbonator; where, if the carbonation canister comprises fluid and the pitcher comprises fluid, the filtration system can: filter fluid from the pitcher and dispense the fluid from the housing if a user activates a first configuration; and filter fluid from the pitcher, mix fluid from the pitcher with fluid from the carbonation canister, and dispense fluid from the housing if a user activates a second configuration. In some embodiments, the pitcher and the filtration unit cooperate to permit fluid communication between an interior of the pitcher and the filtration unit. In some embodiments, the pitcher comprises a valve and the filtration unit comprises a dry break assembly, and the dry break assembly is configured to cooperate with the valve to permit fluid communication between an interior of the pitcher and the filtration unit. Some embodiments further comprise a controller configured to enable a user to activate the first configuration if a user presses a first button and to enable a user to activate the second configuration if a user presses a second button. In some embodiments, further comprise a controller; and a sensor coupled to the controller and configured to detect if fluid enters the filtration unit; where, if a user activates the first configuration or the second configuration, the controller is configured to pump fluid from a pitcher after the sensor detects that fluid has entered the filtration unit. Some embodiments further comprise a controller; a first solenoid; a second solenoid; and a third solenoid; where the controller is configured such that: if a user activates the first configuration, the controller signals to open the first solenoid to permit fluid from the pitcher to move out of the housing; and if a user activates the second configuration, the controller signals to: open the second solenoid to permit fluid from the pitcher to move into the carbonator; and open the third solenoid to permit fluid from the carbonation canister to move into the carbonator. Some embodiments further comprise a flow conditioner configured to control fluid flow after exiting the carbonator, to control fluid pressure after exiting the carbonator, and/or to control fluid mixing after exiting the carbonator. In some embodiments, the filtration unit is configured such that fluid flow is approximately 60 pounds per square inch before exiting the housing. In some embodiments, the flow conditioner maintains the fluid pressure at approximately 60 pounds per square inch. In some embodiments, the pitcher is coupled to a cooling stick configured to cool fluid in the pitcher. Some embodiments further comprise a carbonation canister adjuster configured to permit a user to adjust an amount of fluid exiting the carbonation canister. In some embodiments, the filtration unit is configured to alert a user when the filter should be replaced. In some embodiments, the housing further comprises a carbonation canister compartment configured to accommodate a carbonation canister; and a door configured to open to permit a user to couple a carbonation canister to or decouple a carbonation canister from the housing and configured to close to prevent visibility of the carbonation canister.

Some embodiments of the present methods comprise coupling a pitcher holding fluid to a filtration unit; and activating the filtration unit in one of: a first configuration in which fluid is pumped from the pitcher, through a filter, and out of the filtration unit; and a second configuration in which fluid is pumped from the pitcher, through a filter, through a carbonator to be carbonated, and out of the filtration unit. In some embodiments, activating the filtration unit comprises pressing one or more buttons. Some embodiments further comprise chilling fluid in the pitcher with a cooling stick.

Some embodiments of the present methods comprise engaging a pitcher holding fluid with a filtration unit; and activating the filtration unit in one of: a first configuration in which fluid is pumped from the pitcher, through a filter, and out of the filtration unit; and a second configuration in which fluid is pumped from the pitcher, through a filter, through a carbonator to be carbonated, and out of the filtration unit. In some embodiments, activating the filtration unit comprises pressing one or more buttons. Some embodiments further comprise chilling fluid in the pitcher with a cooling stick.

This disclosure includes designs for pitchers and portions of pitchers. Some of the present pitcher designs include portions that are clear, translucent, transparent, and/or opaque, such as a container portion configured to hold fluid (such as drinking water). Some of the present pitcher designs include a cooling stick. Some of the present pitcher designs include a front of the pitcher (including any part of the front) alone or in combination with other portions of the pitcher or filtration unit, a side of the pitcher (including any part of either side) alone or in combination with other portions of the pitcher or filtration unit, a top of the pitcher (including any part of the top) alone or in combination with other portions of the pitcher or filtration unit, a bottom of the pitcher (including any part of the bottom) alone or in combination with other portions of the pitcher or filtration unit, and a back of the pitcher (including any part of the back) alone or in combination with other portions of the pitcher or filtration unit. In some embodiments, the present pitcher designs do not include the filtration unit, the bottom of the pitcher (or a portion of the bottom), the top of the pitcher (or a portion of the top), either side of the pitcher (or a portion of either side), the front of the pitcher (or a portion of the front), or the back of the pitcher (or a portion of the back).

This disclosure also includes designs (e.g., ornamental designs) for filtration units and portions of filtration units. Some of the present filtration unit designs include a front of the filtration unit (including any part of the front) alone or in combination with other portions of the filtration unit or pitcher, a side of the filtration unit (including any part of either side) alone or in combination with other portions of the filtration unit or pitcher, a top of the filtration unit (including any part of the top) alone or in combination with other portions of the filtration unit or pitcher, a bottom of the filtration unit (including any part of the bottom) alone or in combination with other portions of the filtration unit or pitcher, and a back of the filtration unit (including any part of the back) alone or in combination with other portions of the filtration unit or pitcher. In some embodiments, the present filtration unit designs do not include the pitcher, the bottom of the filtration unit (or a portion of the bottom), the top of the filtration unit (or a portion of the top), either side of the filtration unit (or a portion of either side), the front of the filtration unit (or a portion of the front), or the back of the filtration unit (or a portion of the back).

The terms “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system or unit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

The term “detect” (and any form of detect, such as “detects,” “detected,” and “detecting”) is used broadly throughout this disclosure to include receiving information, obtaining or gathering of information, and any calculations for and/or manipulations of such information that may result in additional information. The term should include terms such as measuring, identifying, receiving, obtaining, gathering, similar terms, and derivatives of such terms.

Further, a structure (e.g., a component of a system or unit) that is configured in a certain way is configured in at least that way, but it can also be configured in other ways than those specifically described.

Any embodiment of any of the present systems, units, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiments depicted in the figures.

FIG. 1 depicts a perspective view of one embodiment of the present filtration systems comprising a pitcher coupled to a filtration unit.

FIG. 2 depicts a perspective view of the filtration system of FIG. 1.

FIG. 3 depicts a front view of the filtration system of FIG. 1.

FIG. 4 depicts a back view of the filtration system of FIG. 1.

FIG. 5 depicts a side view of the filtration system of FIG. 1.

FIG. 6 depicts a side view of the filtration system of FIG. 1.

FIG. 7 depicts a bottom view of the filtration system of FIG. 1.

FIG. 8 depicts a perspective view of a portion of the filtration system of FIG. 1 comprising a filter and a carbonation canister coupled to the housing of the filtration unit.

FIG. 9 depicts a perspective view of a portion of the filtration system of FIG. 1 comprising a filter and a carbonation canister coupled to the housing of the filtration unit.

FIG. 10 depicts a perspective view of the pitcher of the filtration system of FIG. 1.

FIG. 11A-11B depict a perspective view of the cooling stick of the filtration system of FIG. 1.

FIG. 12 depicts a perspective view of a portion (e.g., a dry break assembly) of the filtration system of FIG. 1.

FIG. 13 depicts a perspective view of a portion (e.g., a dry break assembly, solenoids, a controller, a filter, a carbonation canister, a pump, and the like) of the filtration system of FIG. 1.

FIG. 14 depicts a perspective view of a portion (e.g., a dry break assembly, solenoids, a controller, a filter, a carbonation canister, a pump, a carbonator, and the like) of the filtration system of FIG. 1.

FIG. 15 depicts a top perspective view of a portion (e.g., solenoids, a controller, and the like) of the filtration system of FIG. 1.

FIG. 16 depicts a top perspective view of a portion (e.g., solenoids, a carbonator, a flow conditioner, and the like) of the filtration system of FIG. 1.

FIGS. 17A-17B depict a perspective view of another embodiment of the present filtration systems comprising a carbonation canister coupled to the housing and a door configured to open and close.

FIG. 18A depicts a perspective view of another embodiment of the present filtration systems comprising a pitcher coupled to a filtration unit and a carbonation canister adjuster.

FIG. 18B depicts a portion of the filtration system depicted in FIG. 18A.

FIG. 19A depicts a perspective view of another embodiment of the present filtration systems comprising a pitcher coupled to a filtration unit and a carbonation canister adjuster.

FIG. 19B-19D depict a portion of the filtration system depicted in FIG. 19A.

FIG. 20A depicts a perspective view of another embodiment of the present filtration systems comprising a pitcher coupled to a filtration unit and a carbonation canister adjuster.

FIGS. 20B-20C depict a portion of the filtration system depicted in FIG. 20A.

FIG. 21 depicts another embodiment of a carbonation canister adjuster.

FIGS. 22A-22B depict another embodiment of a carbonation canister adjuster.

FIG. 23 depicts a perspective view of one embodiment of the present filtration systems.

FIG. 24 depicts a front view of the embodiment shown in FIG. 23.

FIG. 25 depicts a back view of the embodiment shown in FIG. 23.

FIG. 26 depicts a right side view of the embodiment shown in FIG. 23.

FIG. 27 depicts a left side view of the embodiment shown in FIG. 23.

FIG. 28 depicts a top view of the embodiment shown in FIG. 23.

FIG. 29 depicts a shaded perspective view of one embodiment of the present filtration systems.

FIG. 30 depicts a shaded front view of the embodiment shown in FIG. 29.

FIG. 31 depicts a shaded back view of the embodiment shown in FIG. 29.

FIG. 32 depicts a shaded right side view of the embodiment shown in FIG. 29.

FIG. 33 depicts a shaded left side view of the embodiment shown in FIG. 29.

FIG. 34 depicts a shaded top view of the embodiment shown in FIG. 29.

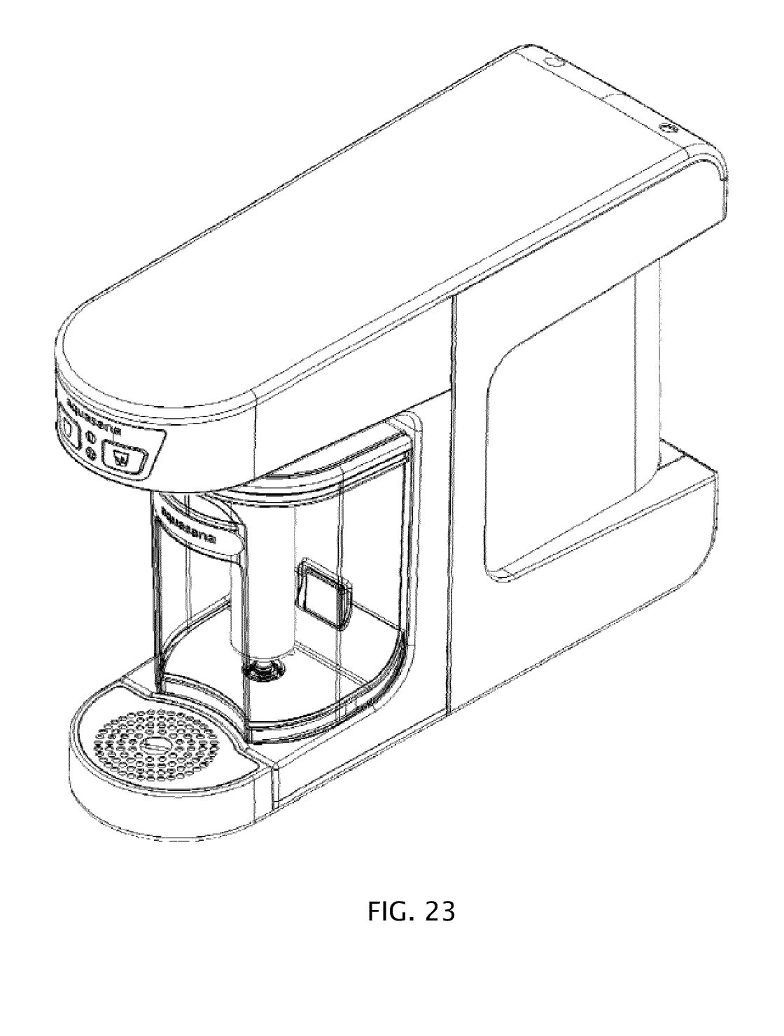

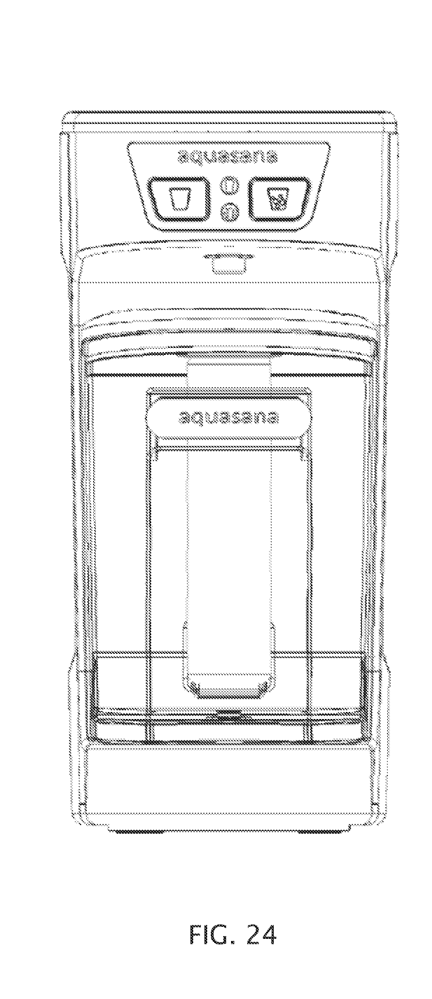

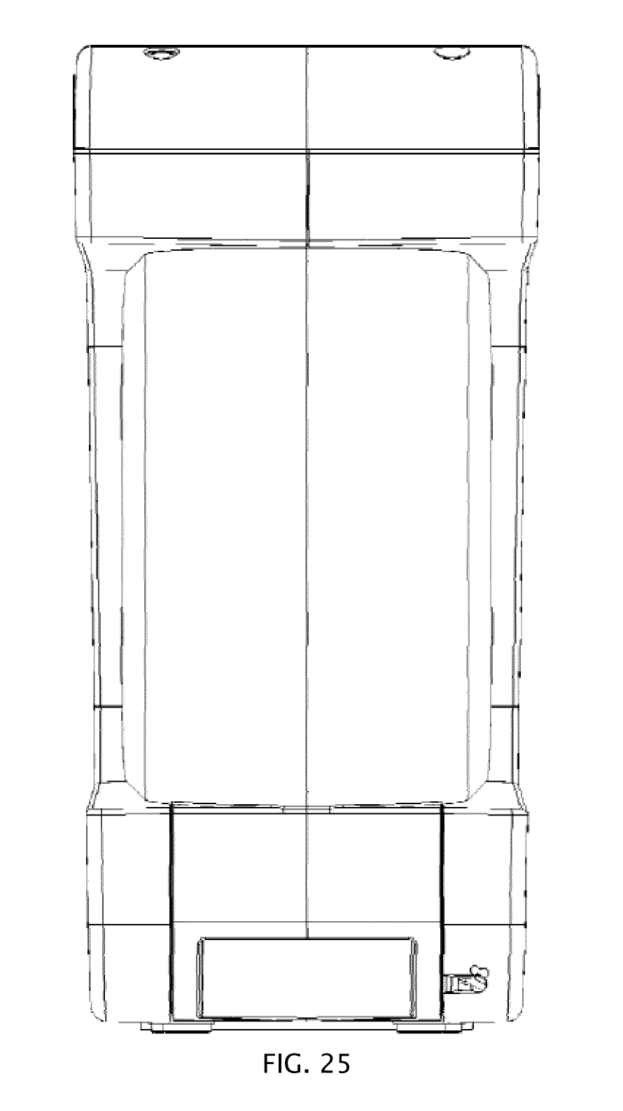

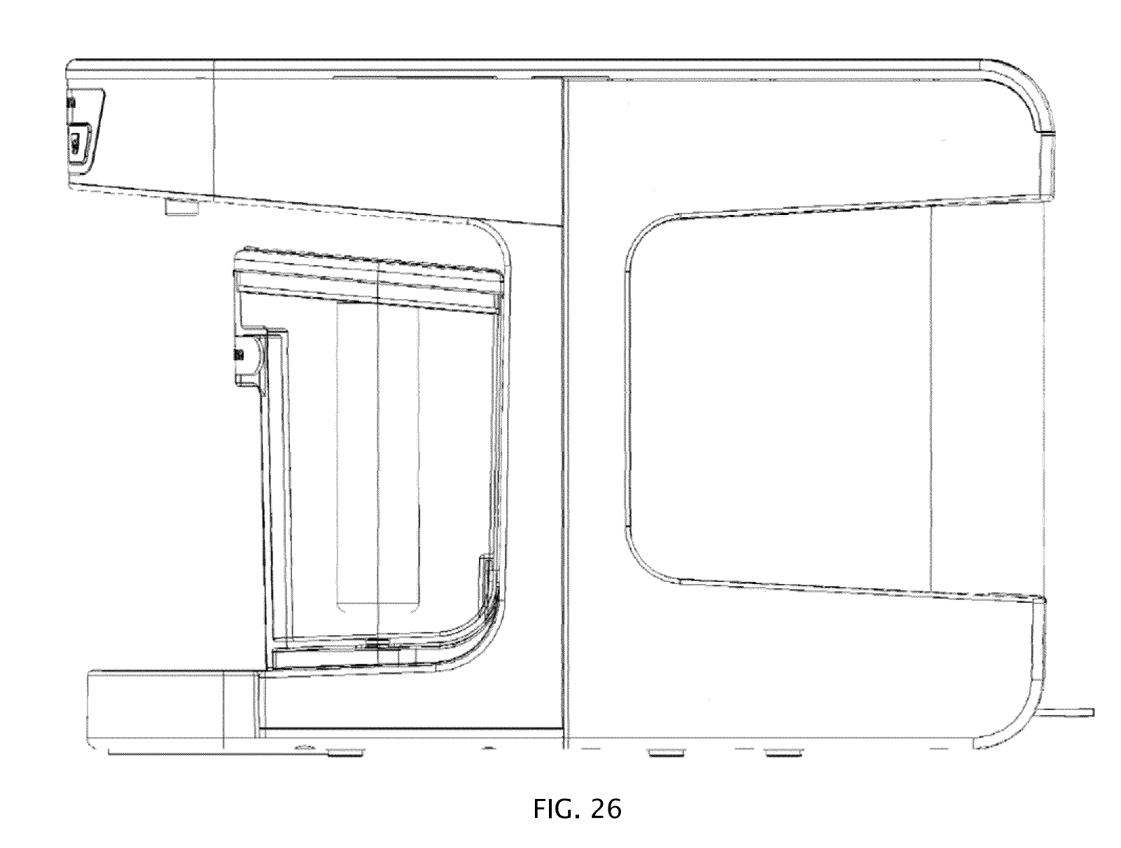

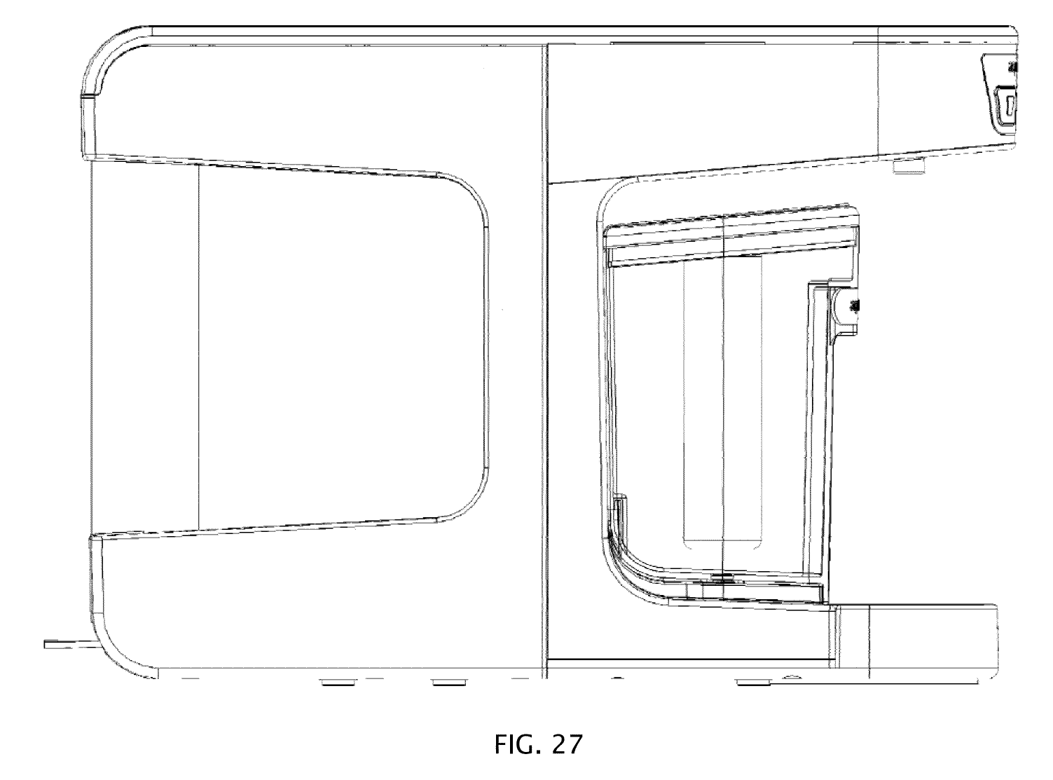

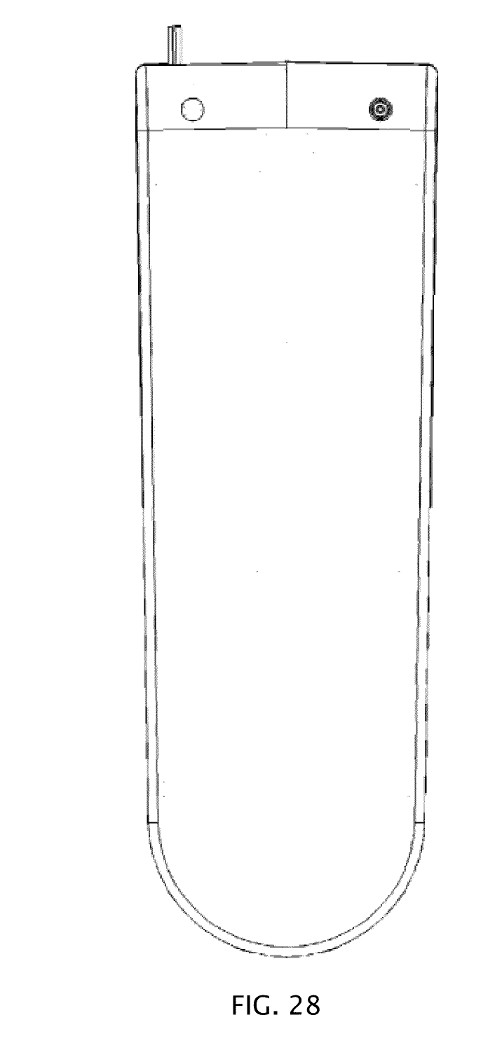

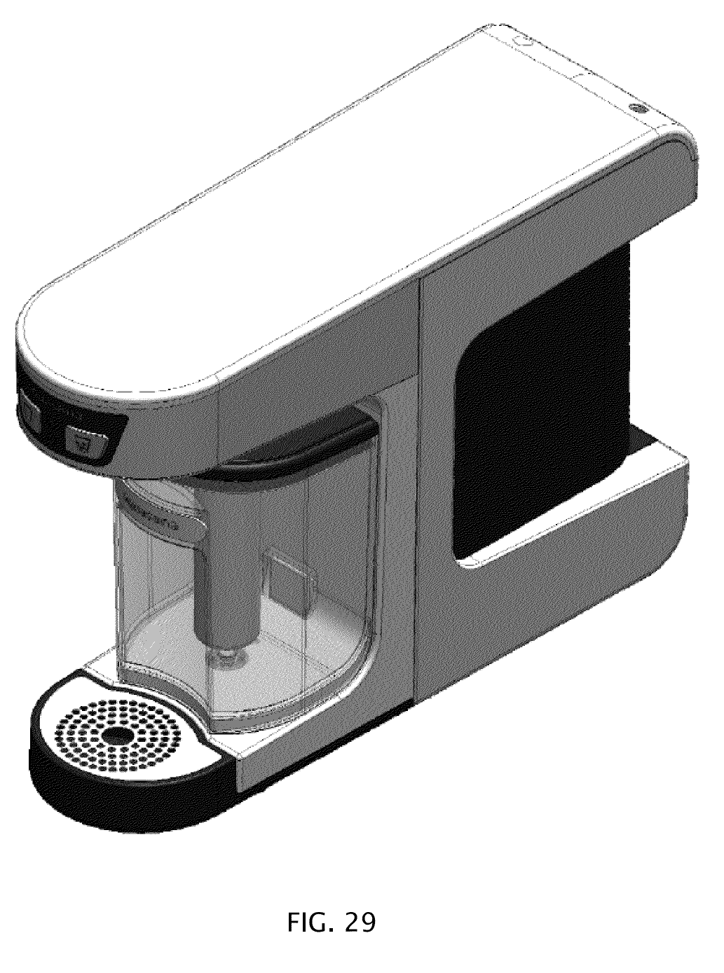

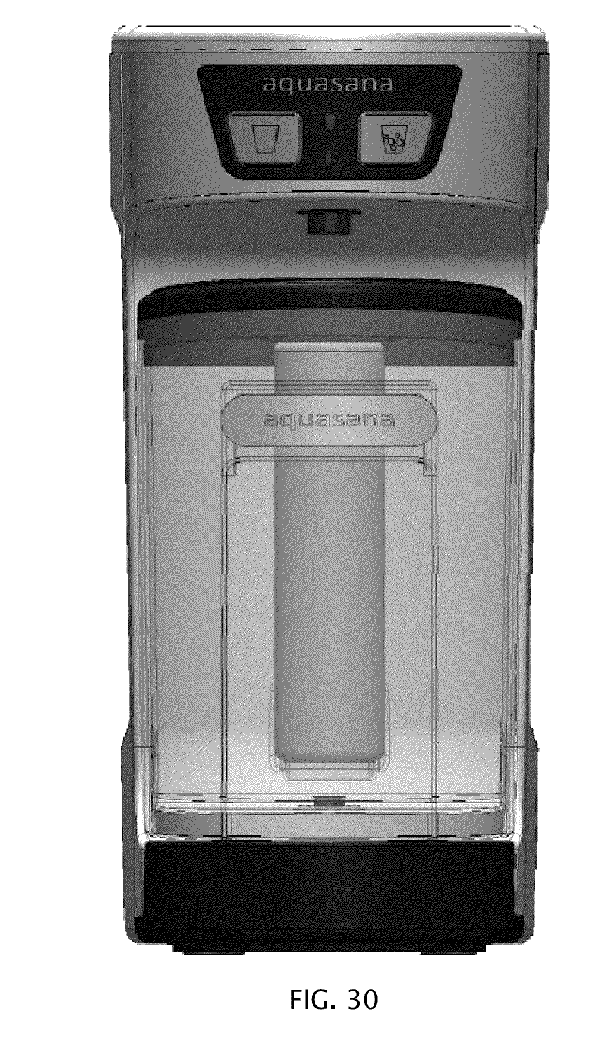

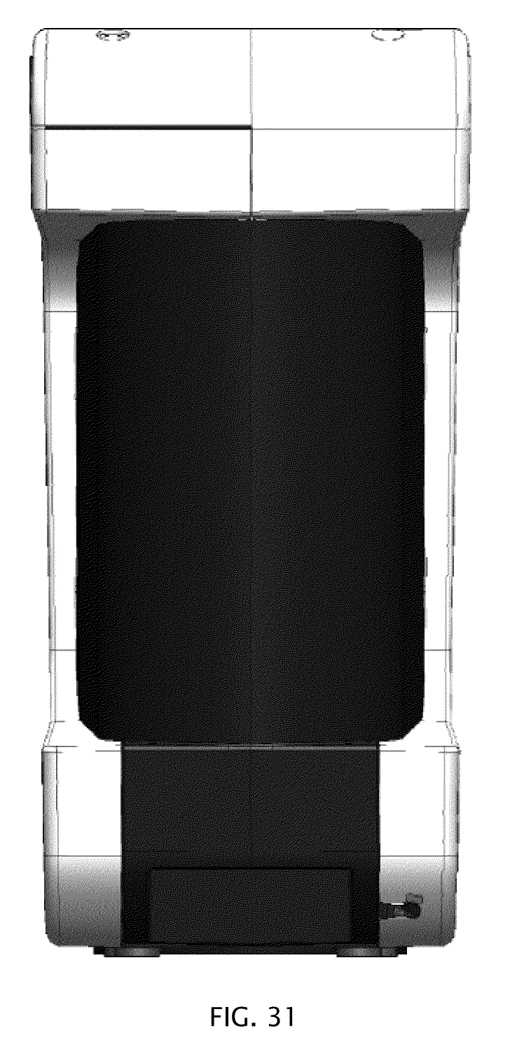

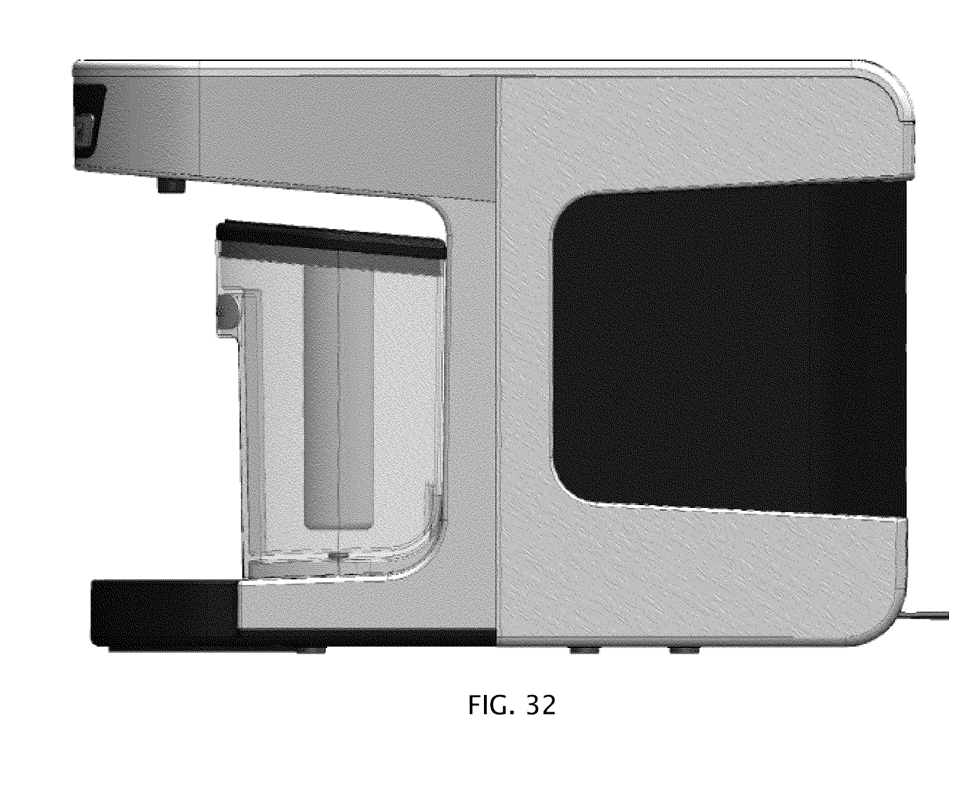

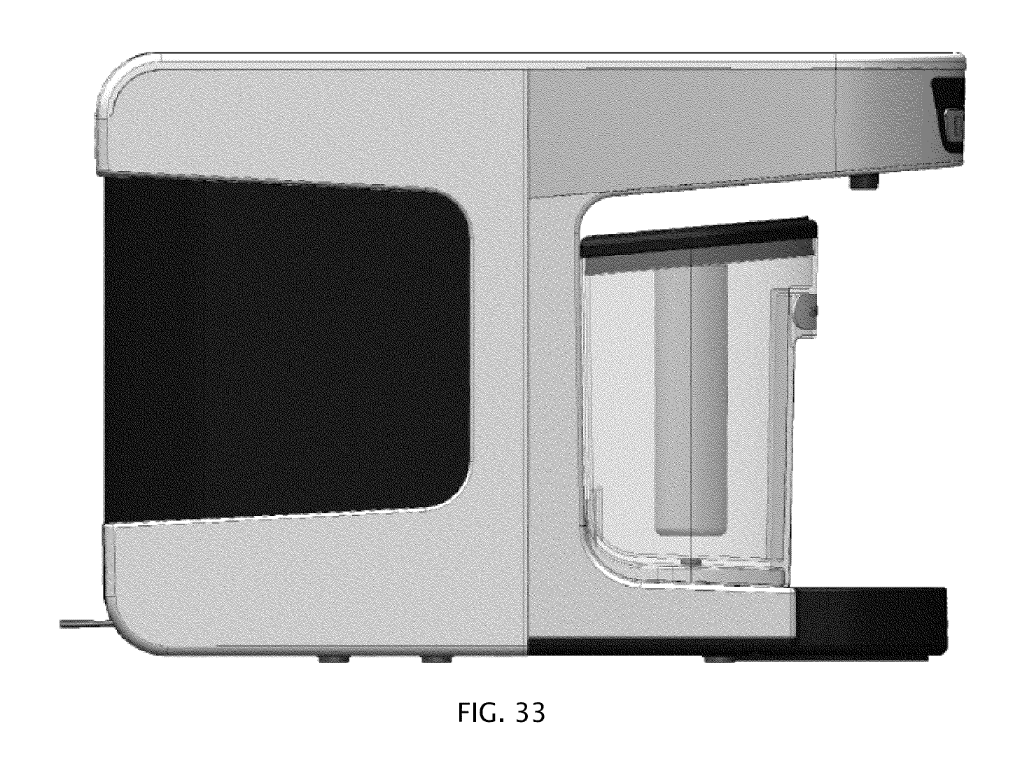

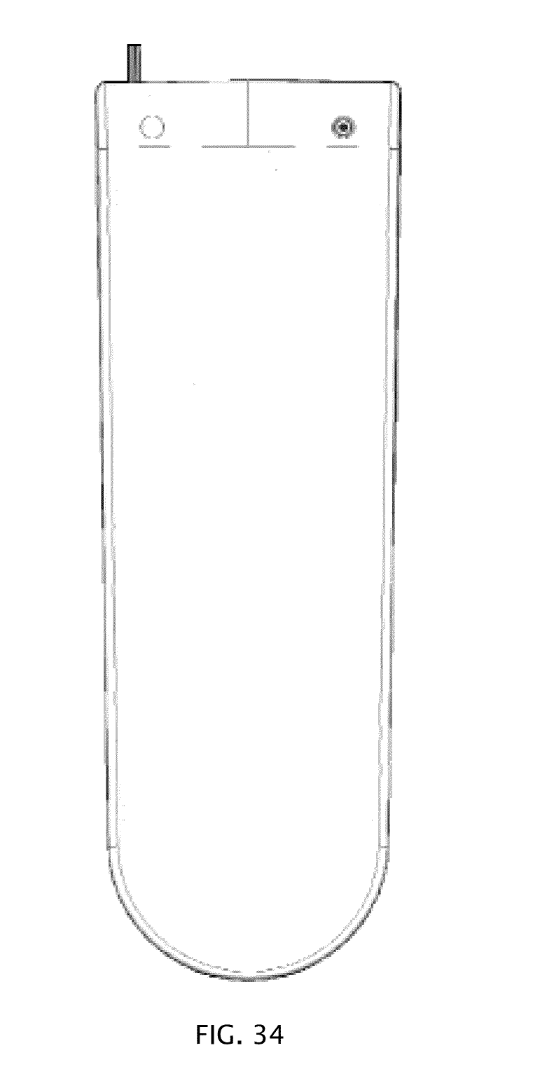

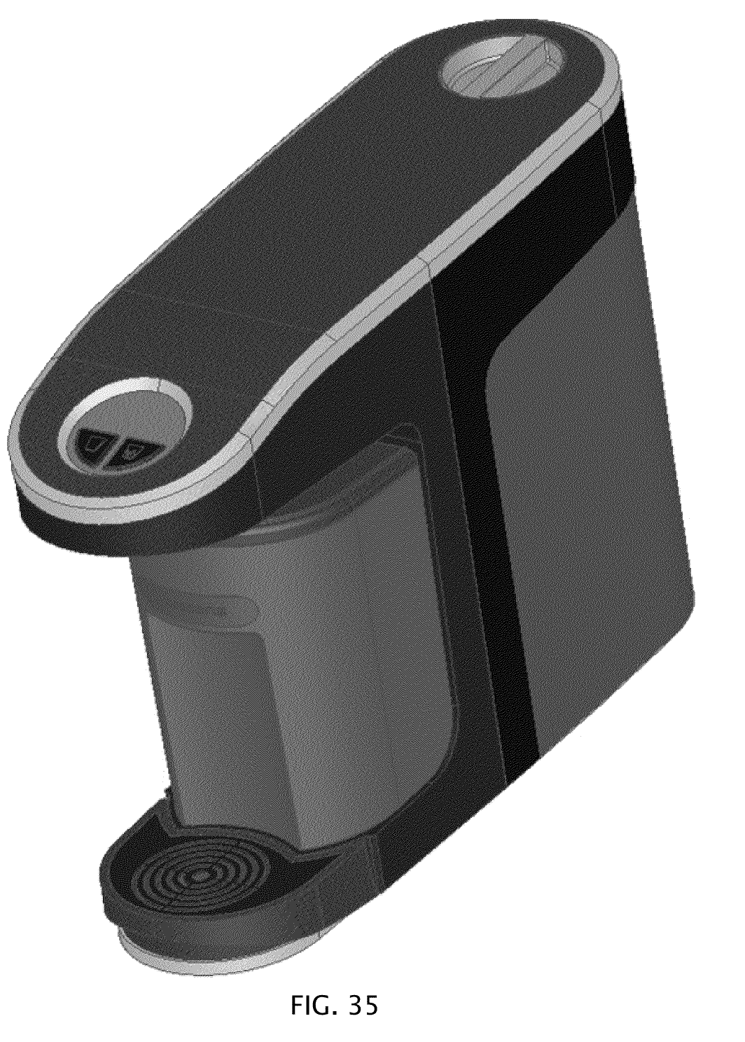

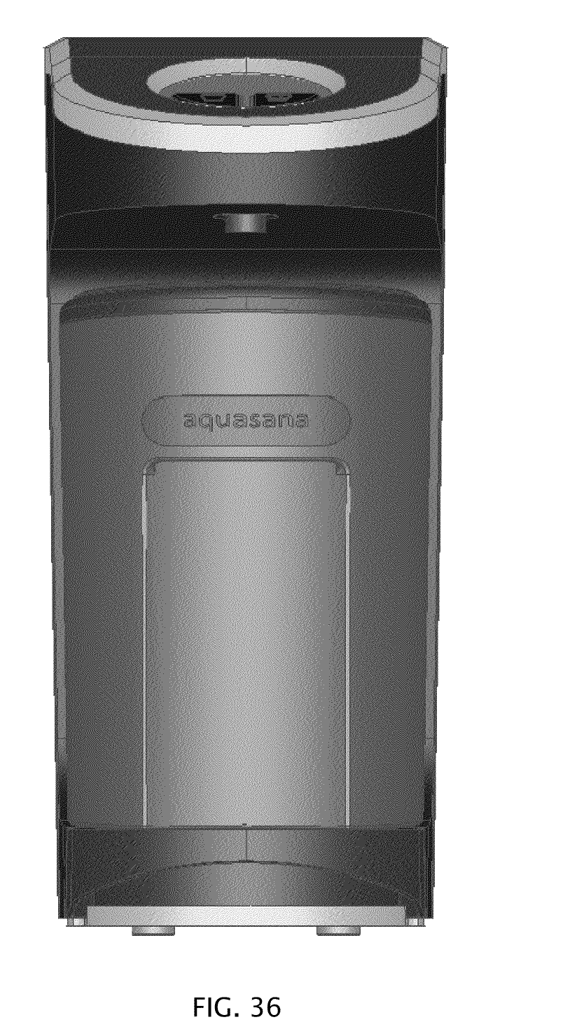

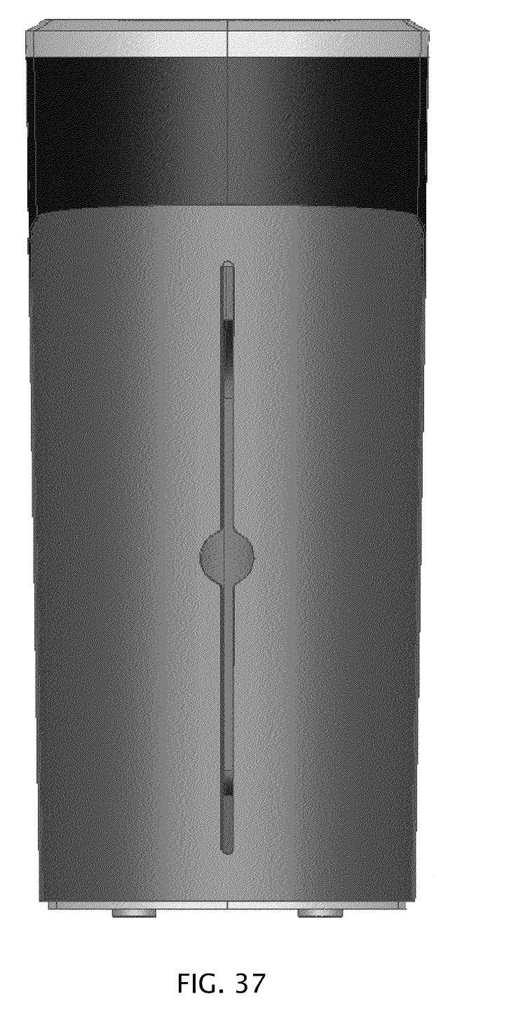

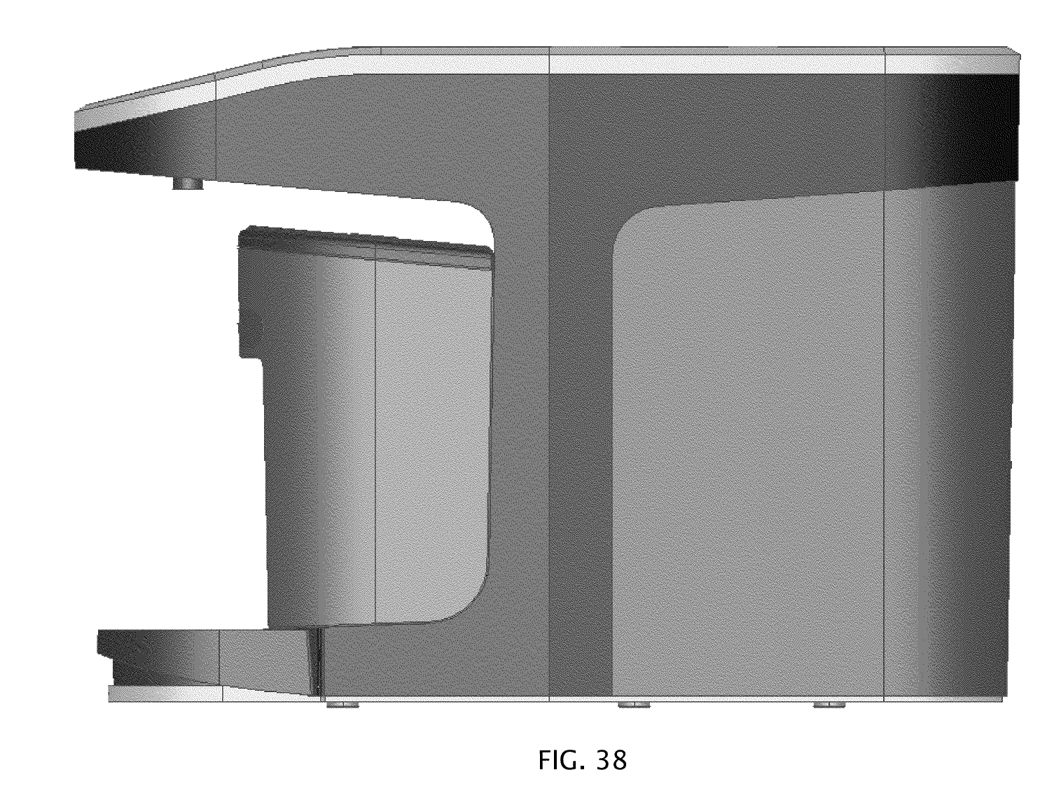

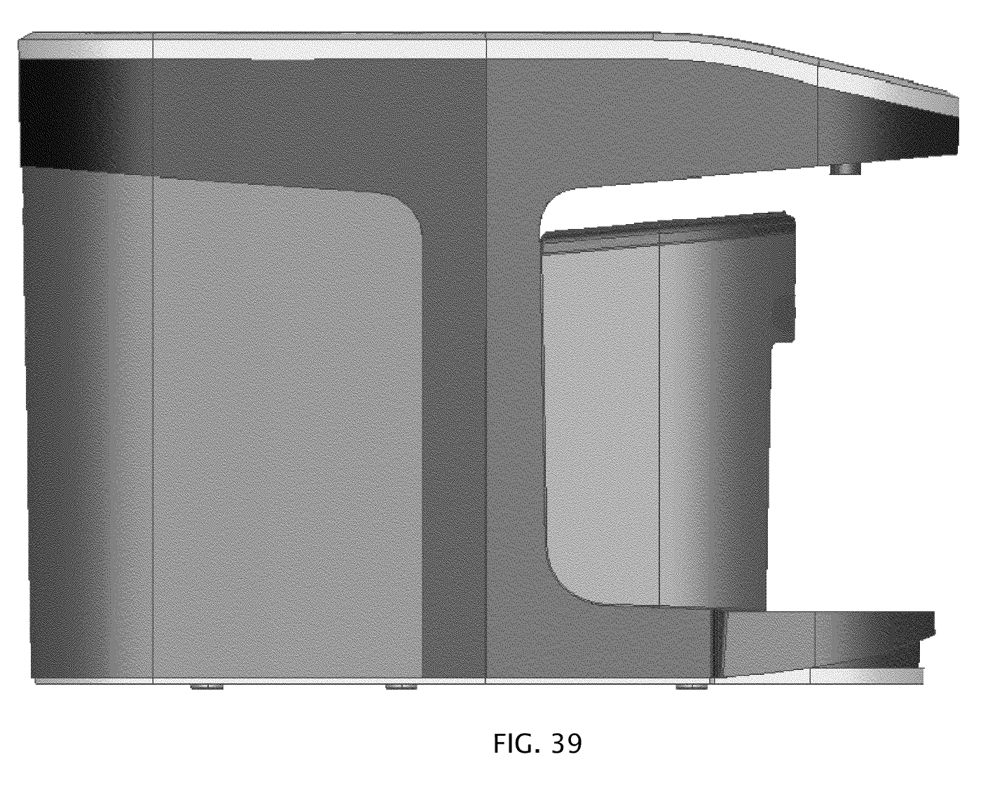

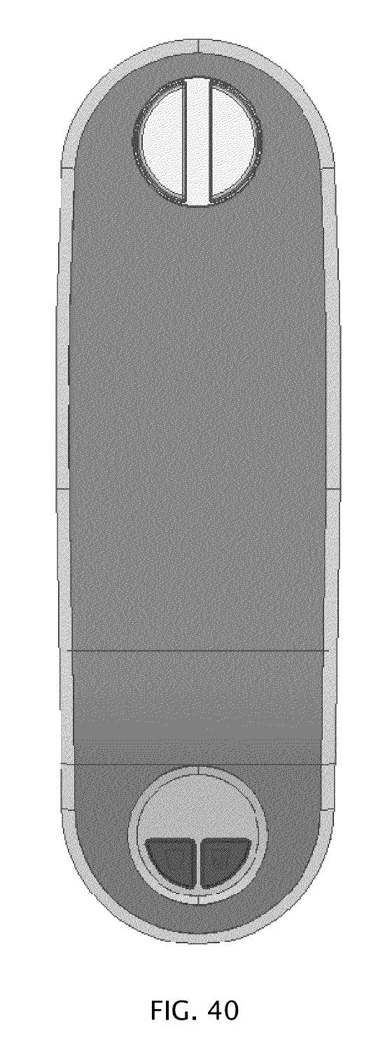

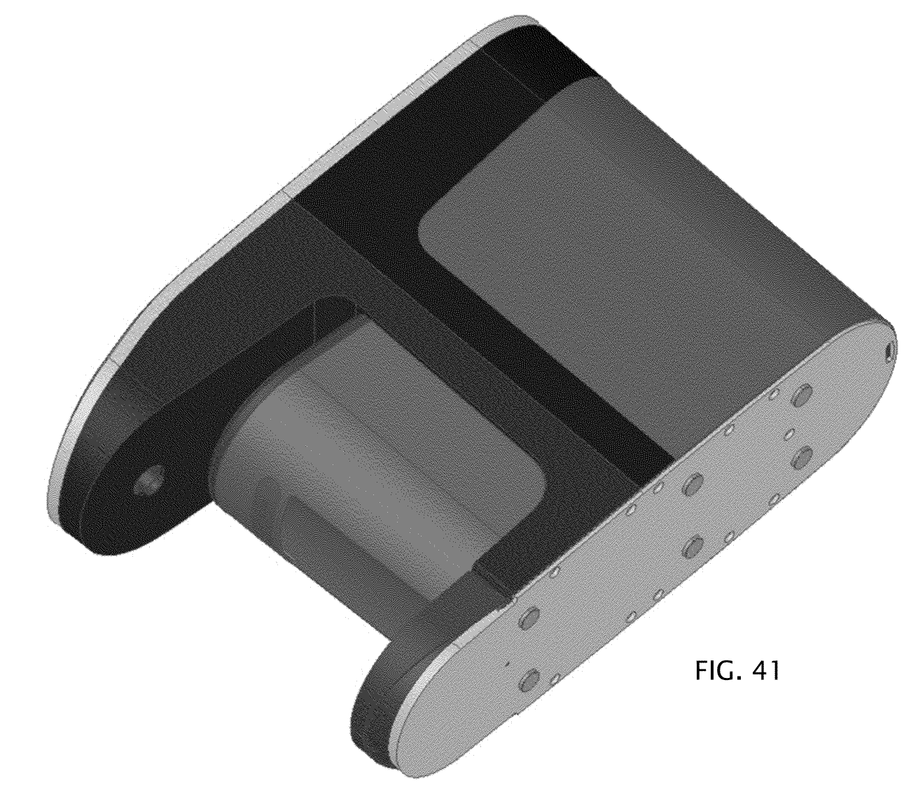

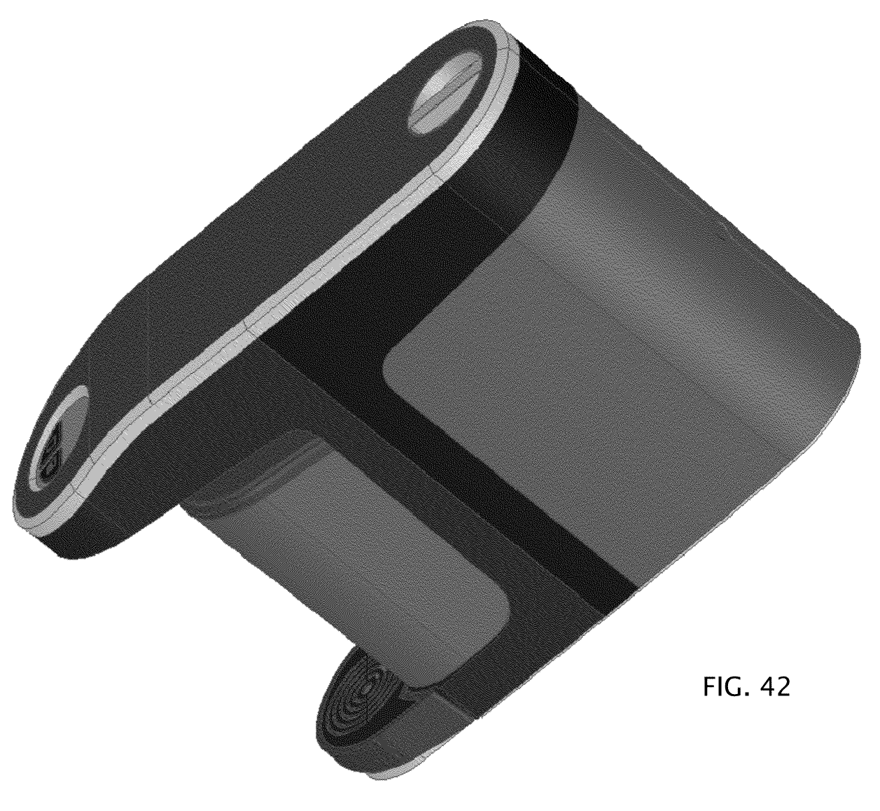

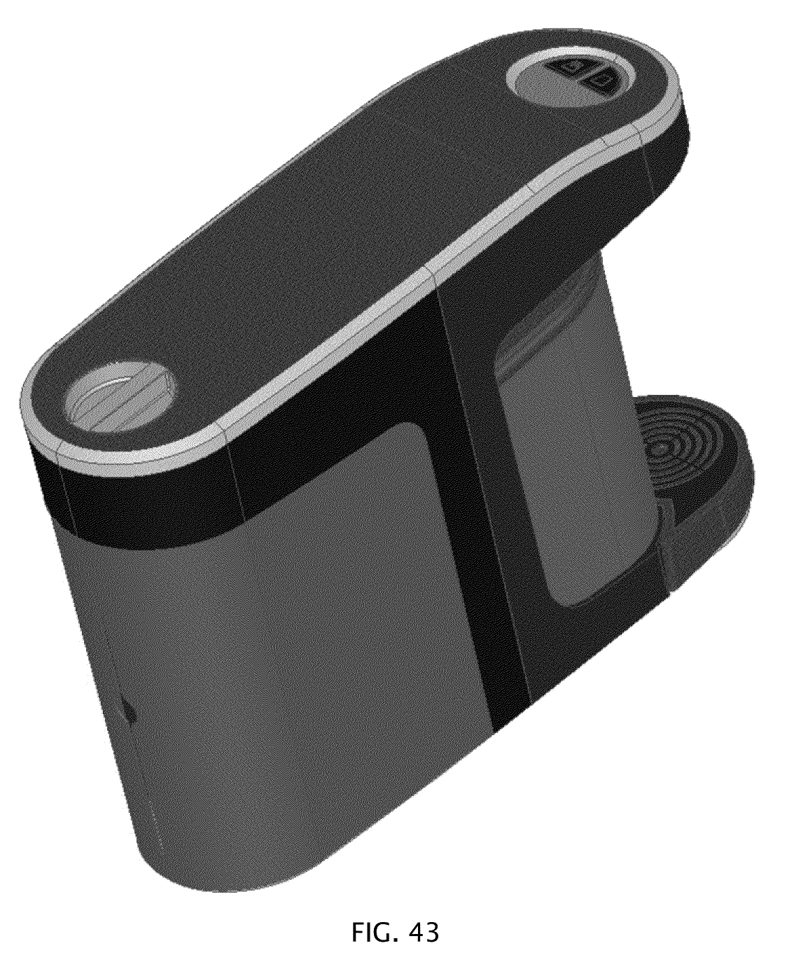

FIGS. 29-34 depicts a shaded view of the embodiment of the present filtration systems depicted in FIGS. 23-28, and those of ordinary skill in the art will understand that changes to or removal of some of the lines in FIGS. 23-38 may be made based on the views in FIGS. 29-34.

FIG. 35 depicts a shaded perspective view of one embodiment of the present filtration systems.

FIG. 36 depicts a shaded front view of the embodiment shown in FIG. 35.

FIG. 37 depicts a shaded back view of the embodiment shown in FIG. 35.

FIG. 38 depicts a shaded right side view of the embodiment shown in FIG. 35.

FIG. 39 depicts a shaded left side view of the embodiment shown in FIG. 35.

FIG. 40 depicts a shaded top view of the embodiment shown in FIG. 35.

FIGS. 41-43 each depicts another shaded perspective view of the embodiment shown in FIG. 35.

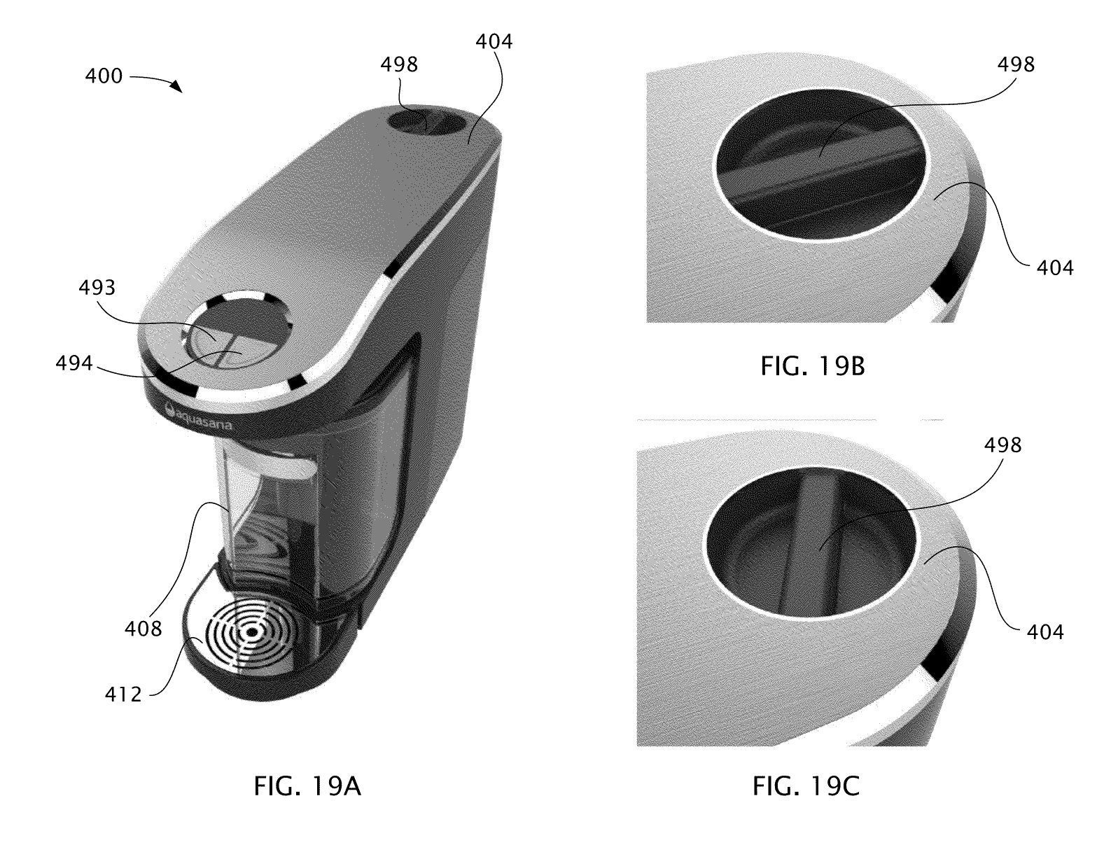

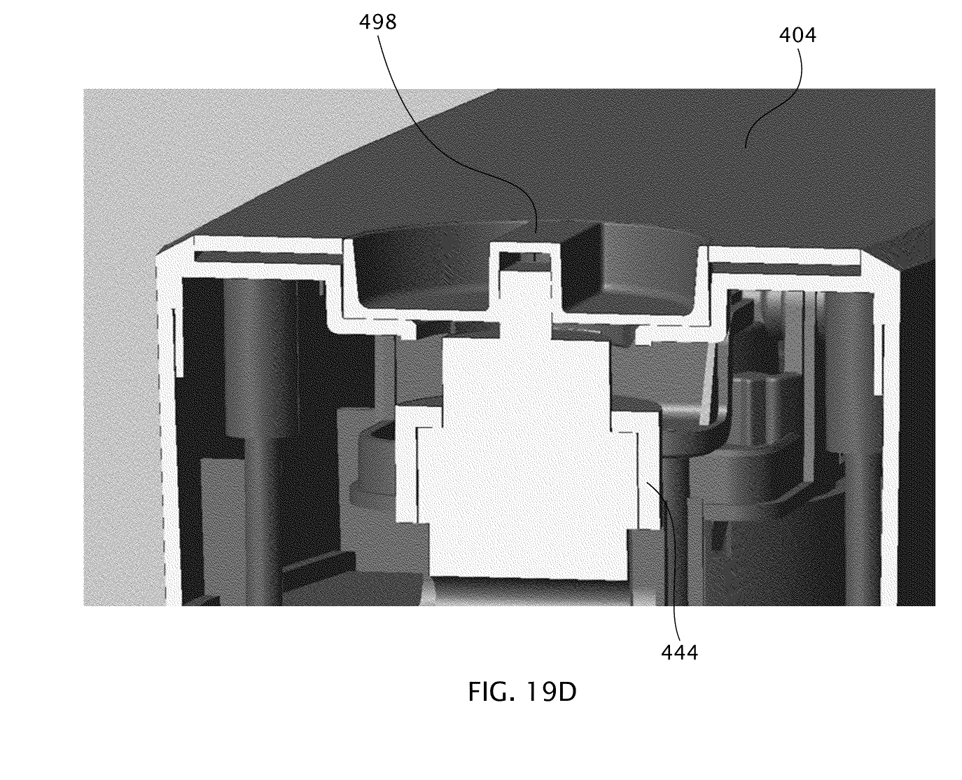

FIGS. 35-43 are additional views of the embodiment shown in FIGS. 19A-19C.

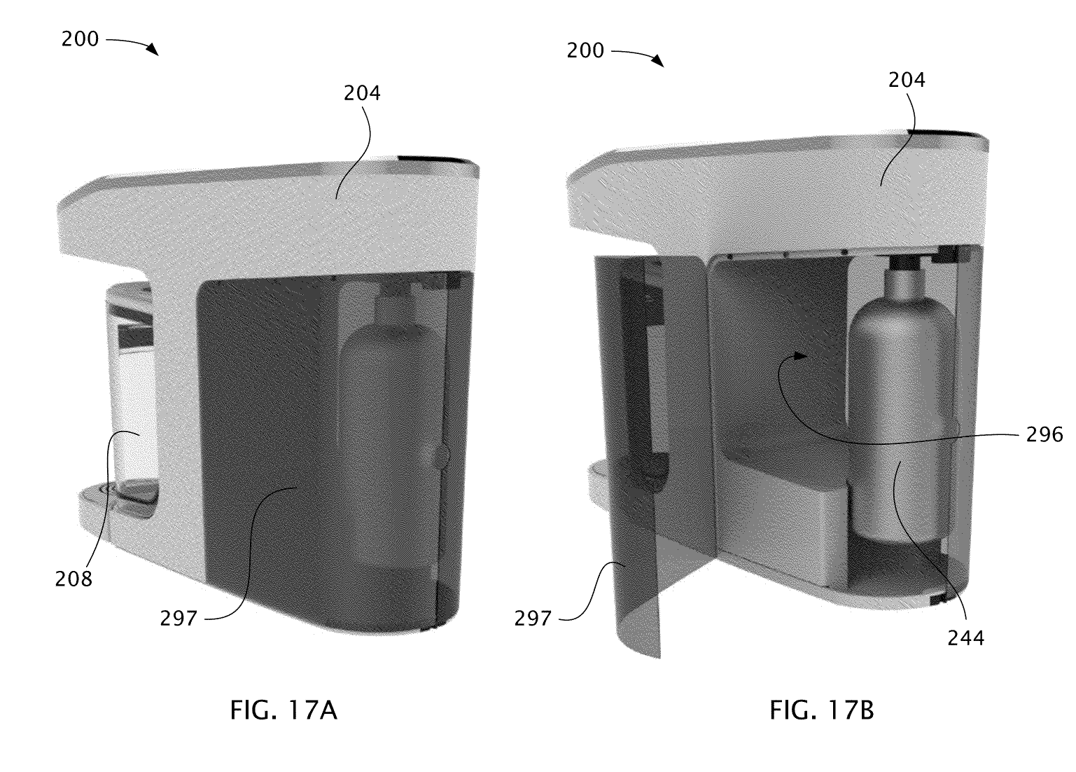

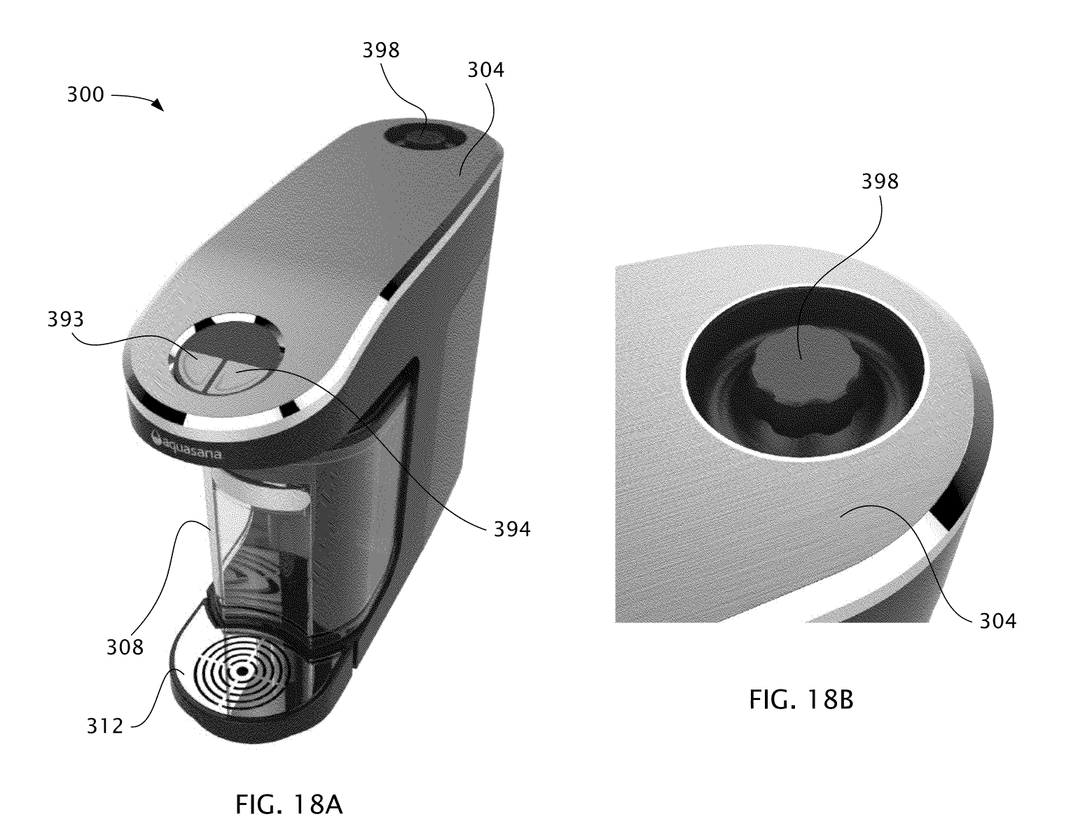

One or more of the present figures may form the basis for one or more design patent applications claiming priority to this application. For example, FIGS. 23 to 28 can form the basis of a design patent application for all or any part of the filtration system depicted therein. FIGS. 29 to 34 can also form the basis of a design patent application for all or any part of the filtration system depicted therein. One of more of FIGS. 17A to 22B can also form the basis of a design patent application for all or any part of the filtration systems depicted therein. FIGS. 35 to 43, and more specifically FIGS. 35-40, can also form the basis of a design patent application for all or any part of the filtration system depicted therein. Those of ordinary skill in the art will understand that the shading from the figures that are shaded (e.g., FIGS. 35-40) may be removed and only the outer profiles of the depicted structures may be shown in such design patent application drawings, and any one or more of the depicted structures (and/or portions of the depicted structures) may be shown as transparent, translucent, opaque, and/or shiny in such design patent application drawings. The filtration systems shown in these figures are symmetrical, meaning that the portions of the systems on either side of a plane that bisects them into two lengthwise (or longitudinal) halves are mirror images of each other. Furthermore, any one or more of the features shown in any of these drawings may be illustrated in dashed lines, thus forming no part of the claimed design. All surface(s) and portion(s) of the filtration systems not shown in FIGS. 17A and 18A, in FIGS. 23-28, in FIGS. 29-34, and in FIGS. 35-43 (and more specifically in FIGS. 35-40), respectively (such as the bottom surface not shown in some of those figures), or otherwise described in the specification may form no part of any future claimed design based on those and/or other of the present figures.

### DESCRIPTION OF ILLUSTRATIVE EMBODIMENTS

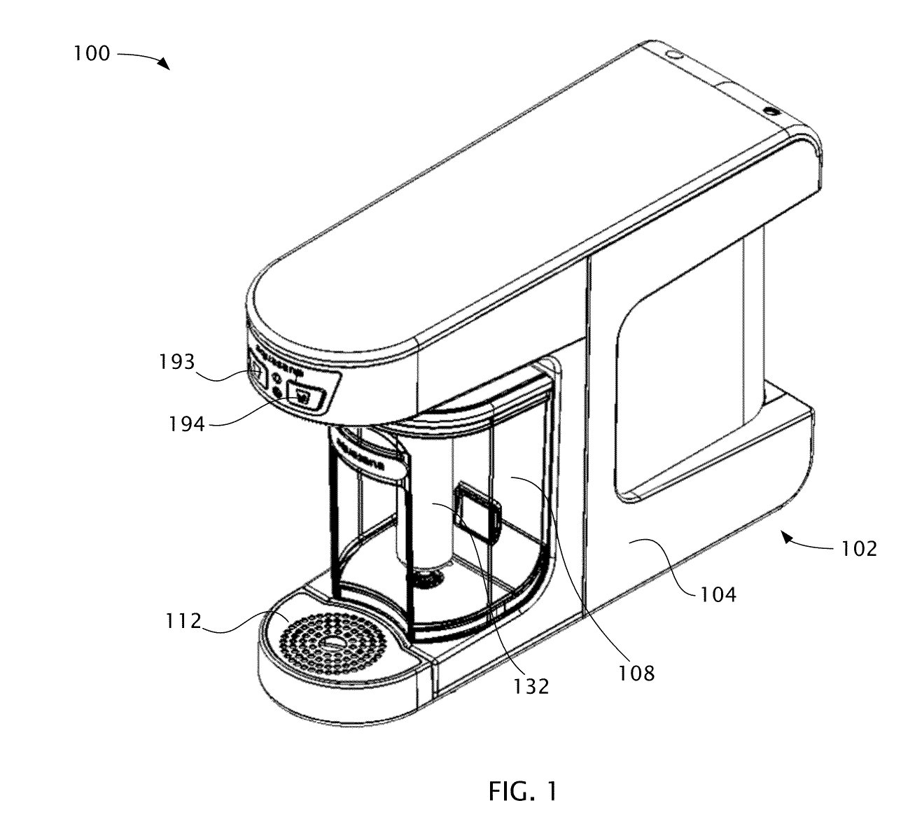

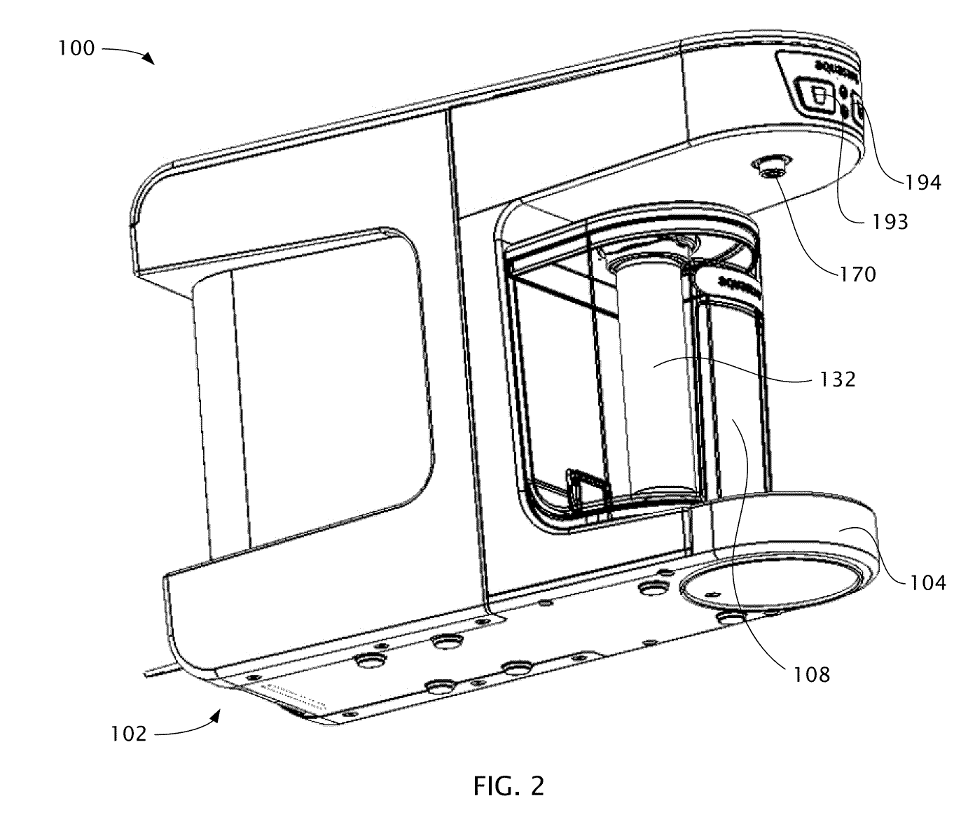

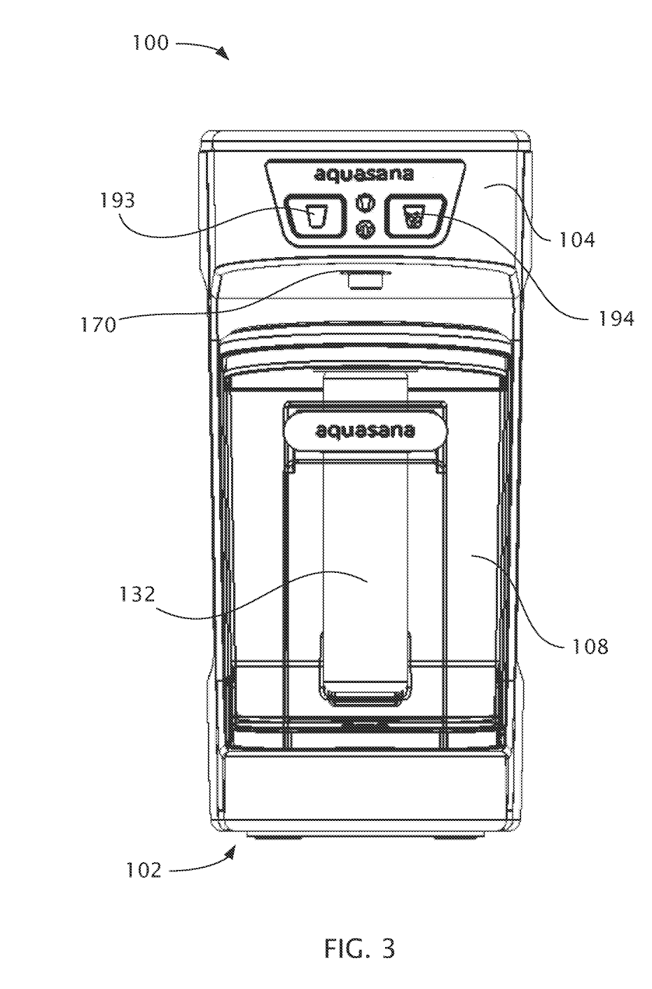

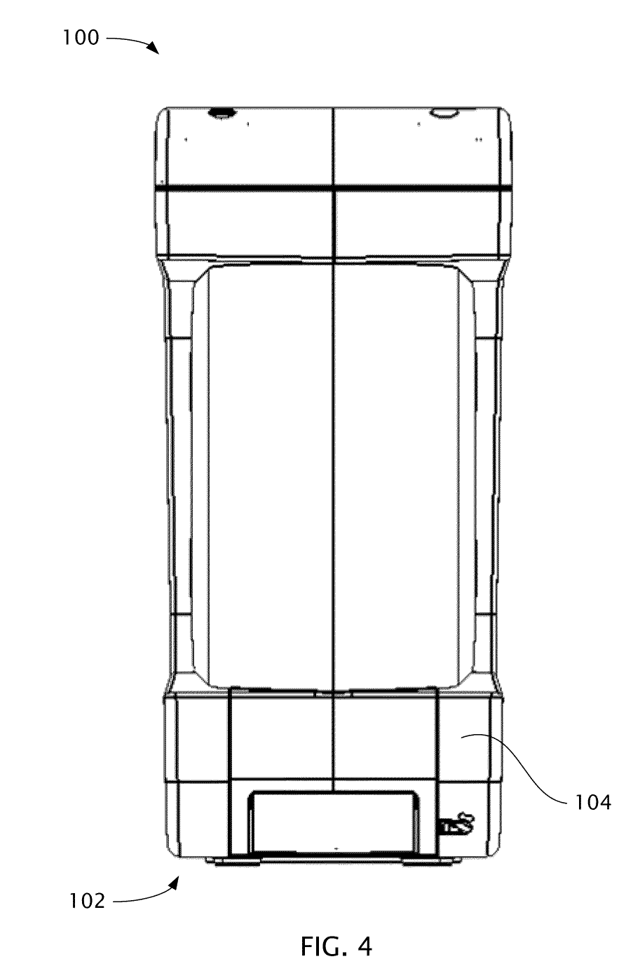

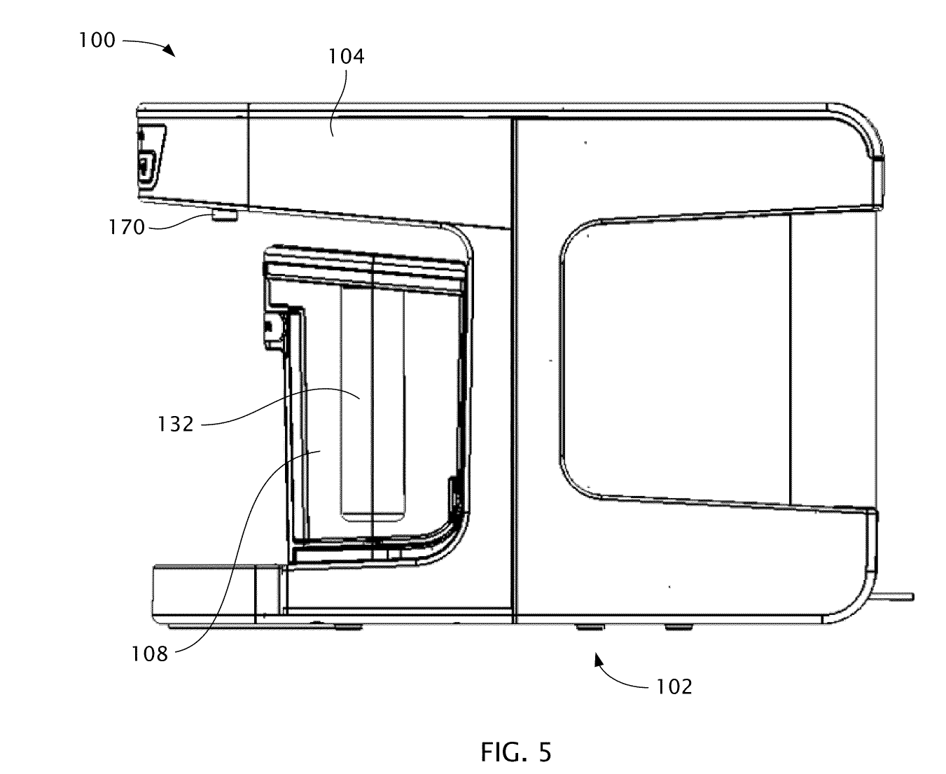

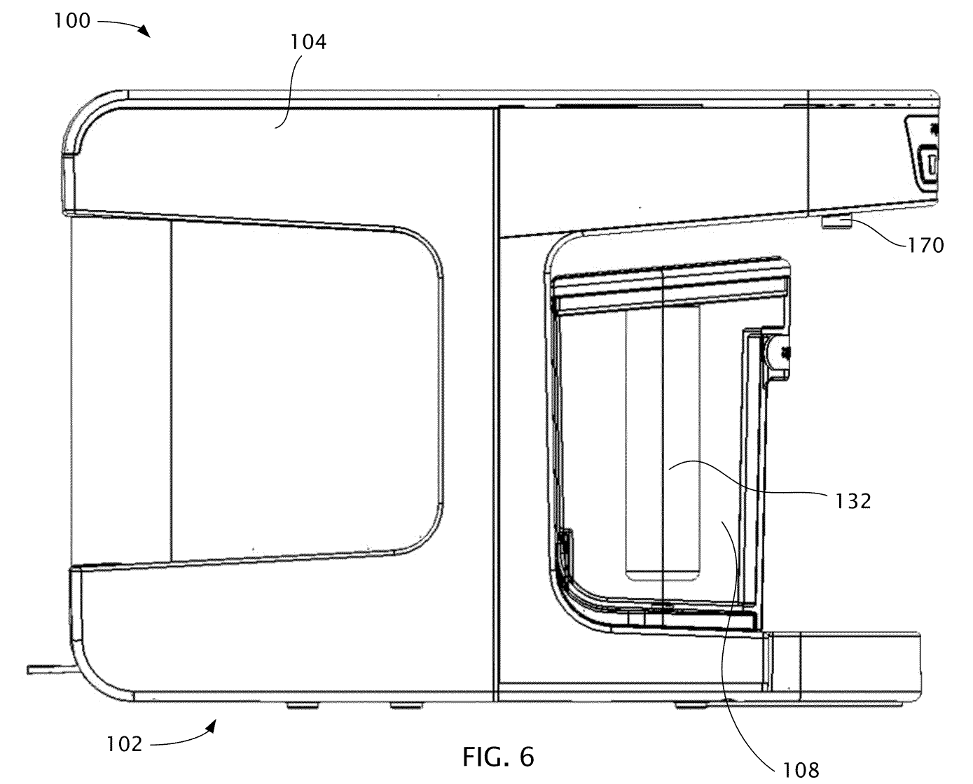

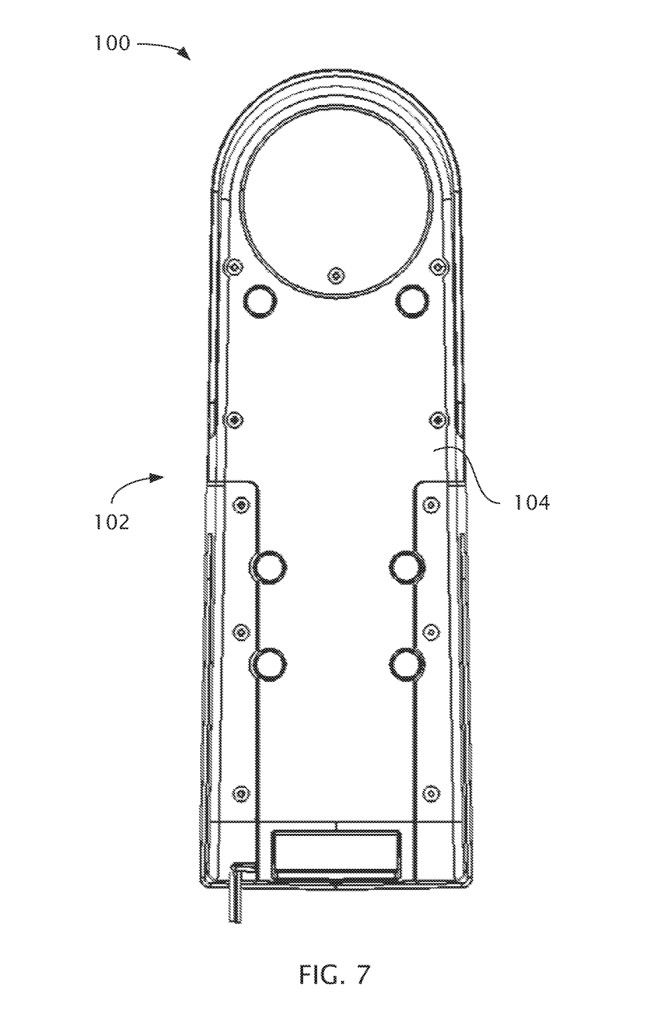

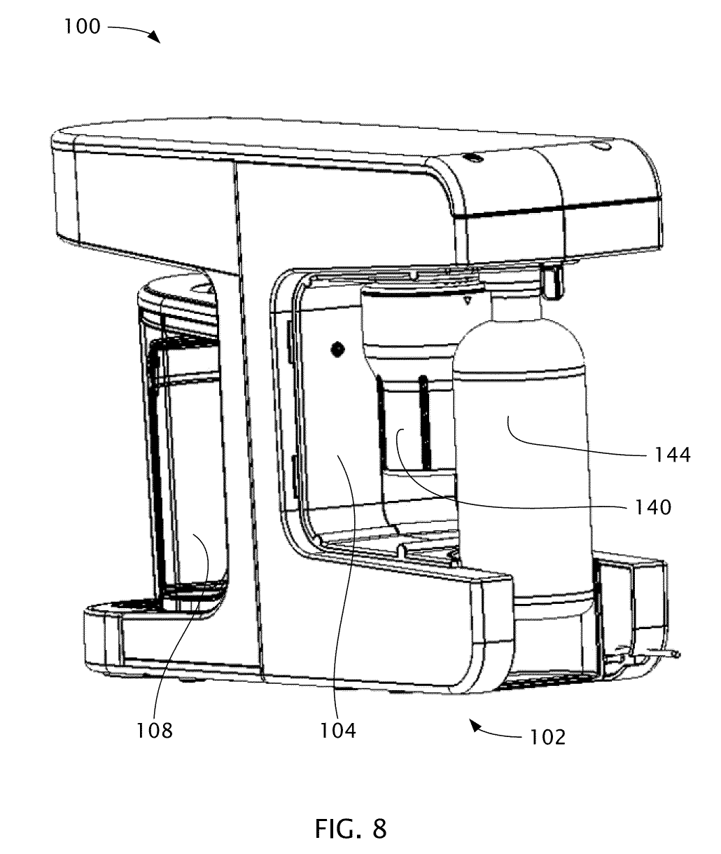

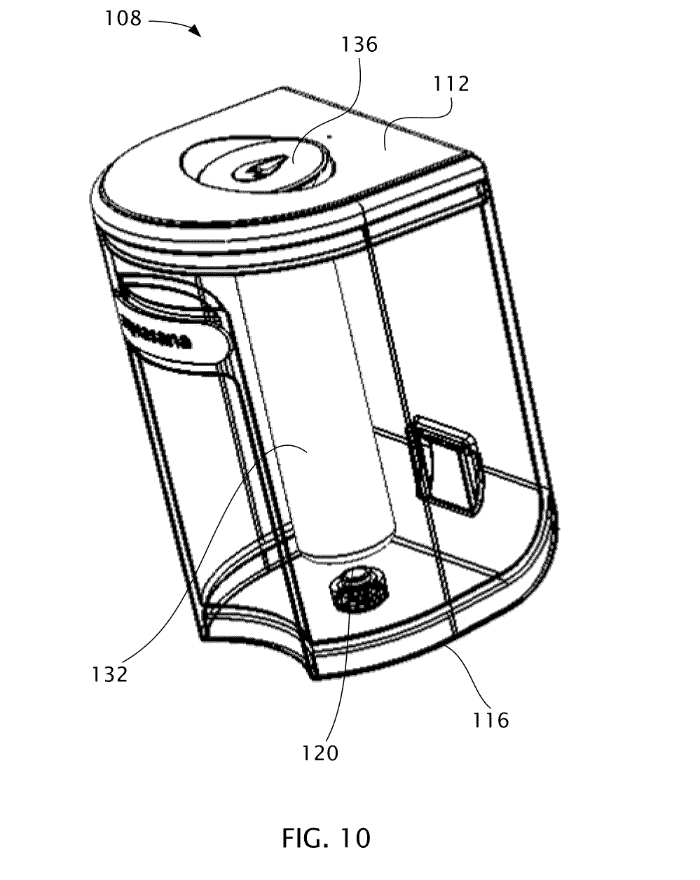

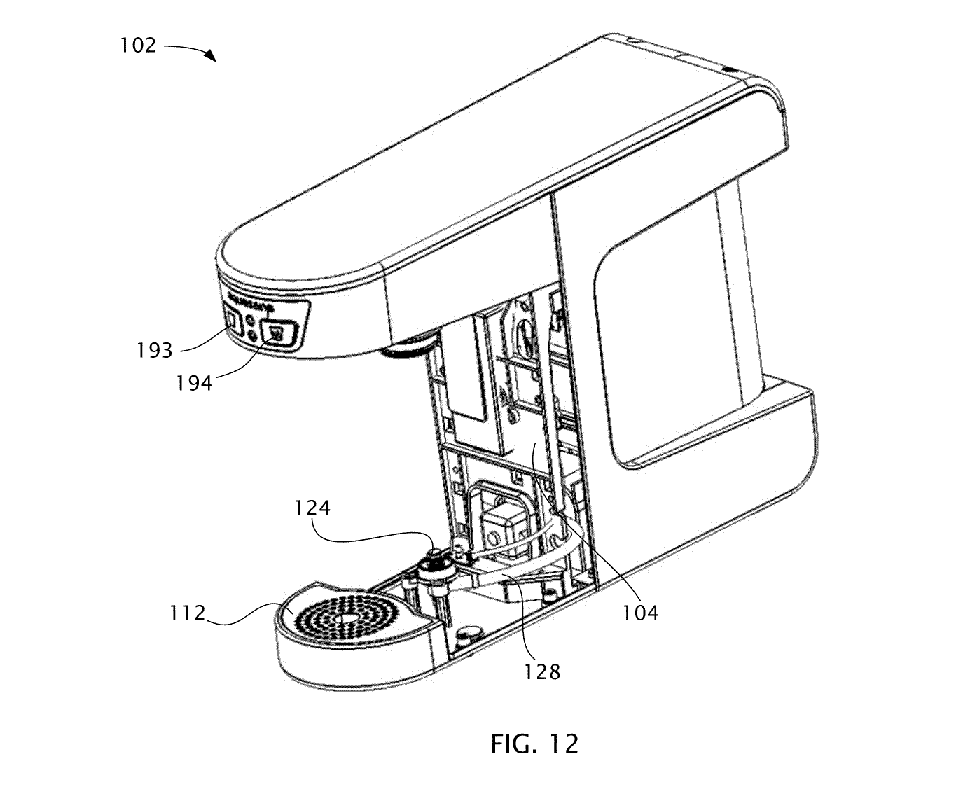

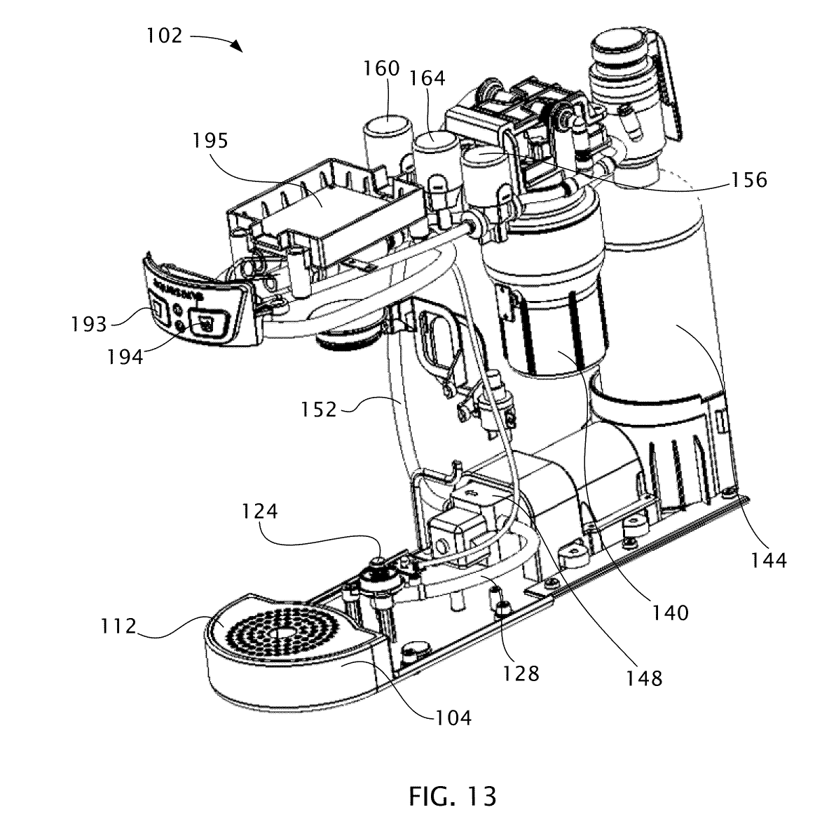

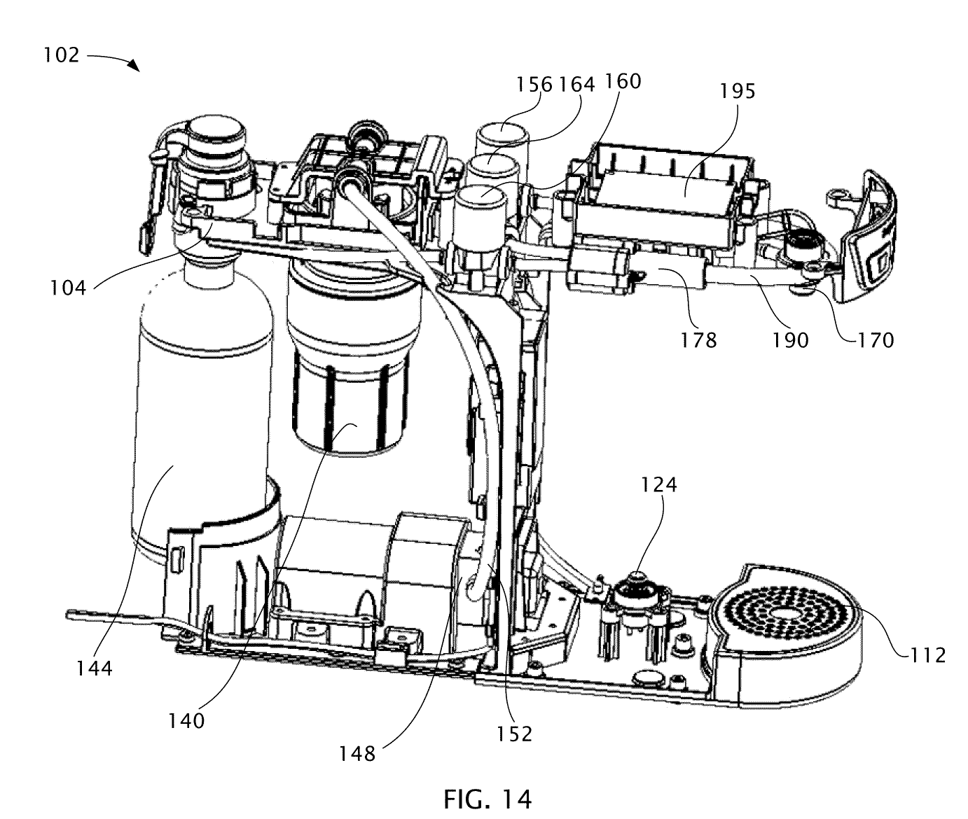

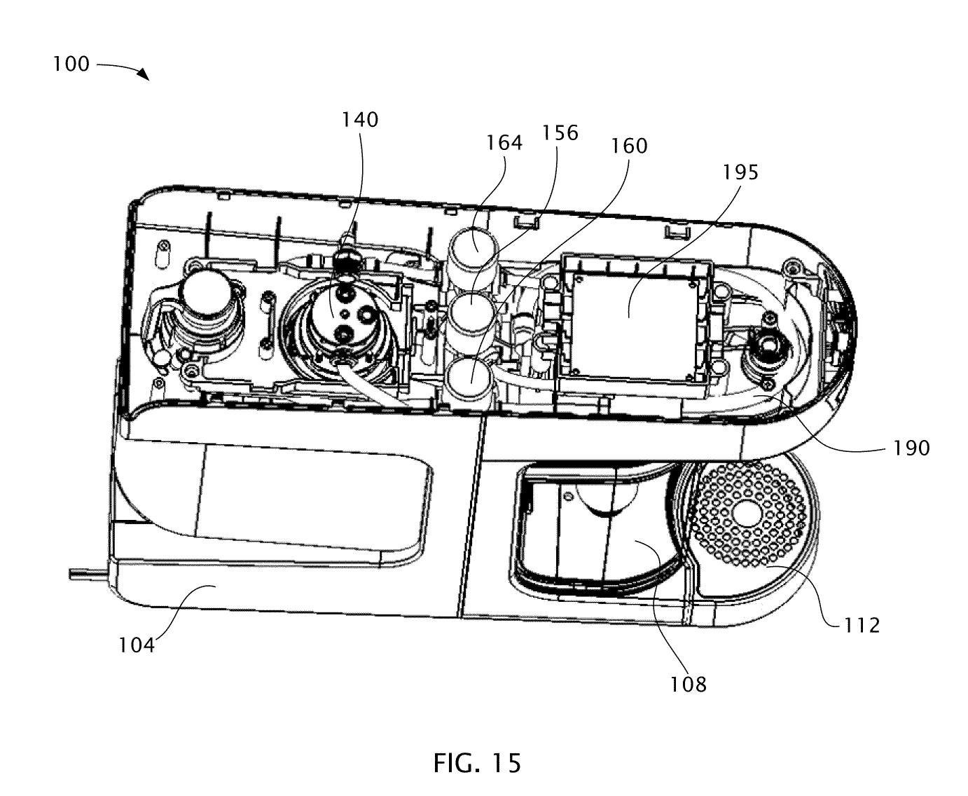

Referring now to the drawings, and more particularly FIGS. 1-16, shown therein and designated by reference number 100 is one embodiment of the present filtration systems. Filtration systems of this disclosure can be used, for example, to filter tap water for drinking. In the embodiments shown, filtration system 100 comprises filtration unit 102. Filtration unit 102 includes housing 104, which is configured to be coupled to a pitcher (and is coupled to pitcher 108, for example, in the embodiment shown in FIG. 1). The present systems, filtration units, and pitchers can be made with standard materials (e.g., plastics, metals, and the like) using standard manufacturing techniques (e.g., injection molding) and/or with materials that can be purchased commercially (e.g., O-rings, nipples, screws, and the like). Housing 104 can comprise any suitable shape configured to at least partially accommodate a pitcher (e.g., pitcher 108), such as an H-like configuration having two recessed portions (e.g., as shown in FIG. 8), one of which is configured to accommodate pitcher 108 and the other of which is configured to accommodate a filter and a carbonation canister (discussed in detail below). Housing 104 can also include drain 112, which can assist in preventing fluid from spilling onto areas surrounding filtration system 100.

As shown in FIGS. 1-3, 5-6, 8-9, and 15-16, filtration unit 102 (and, more specifically, housing 104) is coupled to pitcher 108. Pitcher 108 comprises lid 112, base 116, and valve 120, which is disposed in base 116. Valve 120 and dry break assembly 124 of filtration unit 102 are configured to cooperate to permit fluid communication between an interior of pitcher 108 and filtration unit 102. For example, as shown in FIGS. 1-3, 5-6, 8-9, and 15-16, valve 120 of pitcher 108 is biased in a closed configuration such that if pitcher 108 is uncoupled from filtration unit 102, valve 120 remains in a closed configuration to prevent fluid in pitcher 108, if any, from exiting pitcher 108. If pitcher 108 is coupled to filtration unit 102, dry break assembly 124 and valve 120 cooperate to permit valve 120 to move into an open configuration, further permitting fluid in pitcher 108, if any, to exit pitcher 108 and enter filtration unit 102. Dry break assembly 124 is configured to substantially prevent fluid from exiting filtration system 100, such as by providing a fluid-tight seal (e.g., using O-rings). As will be discussed in detail below, fluid can move via tubing 128 into other components of filtration unit 102.

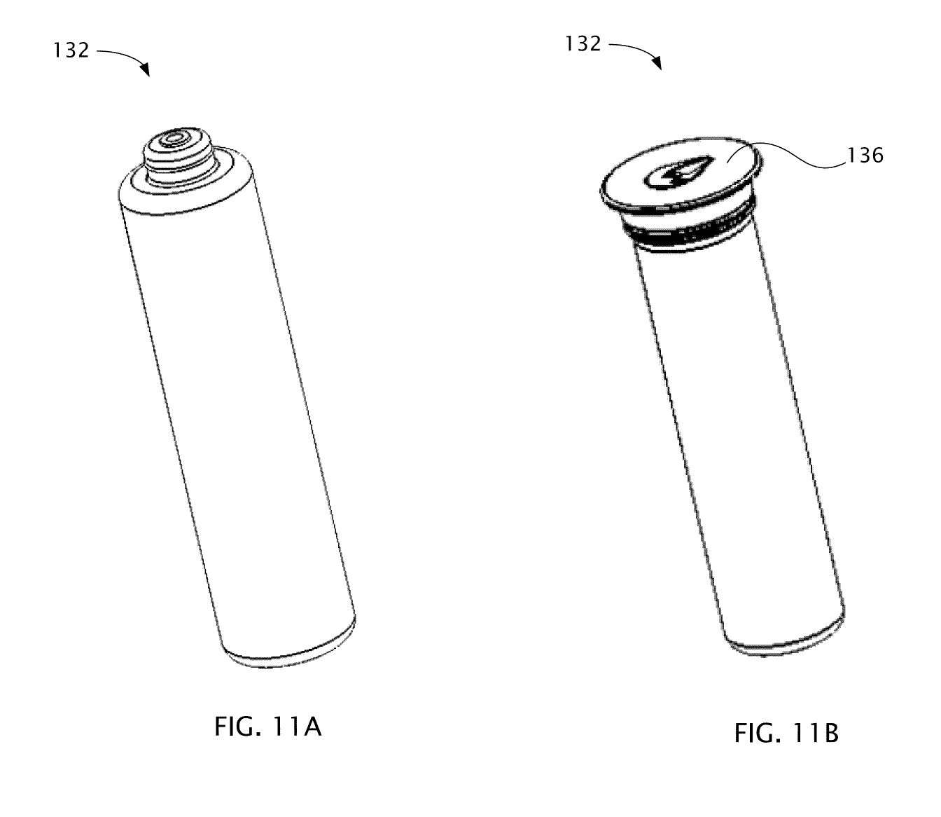

As shown in FIGS. 1-3, 5, and 9-10, pitcher 108 is coupled to cooling stick 132, which is depicted alone in FIGS. 11A-11B. In the embodiment shown, cooling stick 132 is substantially cylindrical; however, in other embodiments, cooling stick 132 can comprise any suitable shape that can be accommodated by a pitcher to which it is coupled (e.g., pitcher 108), such as substantially rectangular, substantially trapezoidal, and the like. Pitcher 108 comprises an opening in lid 112 that is sized to accommodate cooling stick 132 (e.g., the opening in lid 112 is substantially circular and comprises a larger diameter than the diameter of cooling stick 132, in the embodiment shown). Cooling stick 132 can be introduced into pitcher 108 through the opening in lid 112. In the embodiment shown in FIG. 11B, cooling stick 132 is coupled (e.g., threadably) to cooling stick lid 136. Cooling stick lid 136 is configured to interact with and/or couple to lid 112 of pitcher 108 to, for example, prevent fluid in pitcher 108, if any, from exiting pitcher 108 through the opening in lid 112 and to prevent cooling stick 132 from moving toward base 116 of pitcher 108 after cooling stick lid 136 interacts with and/or couples to lid 112 of pitcher 108. Cooling stick 132 comprises a chillable or freezable fluid or solid, such as water, refrigerants, gels, and the like, such that if cooling stick 132 is chilled or frozen and disposed in pitcher 108 having a fluid, heat from the fluid in pitcher 108 can transfer into cooling stick 132 (and, more specifically, into the fluid or solid within cooling stick 132) to chill the fluid in pitcher 108.

The present filtration systems, including filtration system 100 (and more specifically housing 104 of filtration unit 102), are configured to be coupled to a filter, such as filter 140, for example, in the embodiment shown in FIG. 8. Filters in this disclosure can be similar in construction and/or material to the filters found in the Model AQ-4000, AQ-4025, or AQ-4035 filter assemblies (e.g., Cartridge A and/or Cartridge B of either Model) available from Aquasana, Inc., Austin, Tex., USA. As such, the filters may comprise carbon, and, more specifically, may be characterizable as activated carbon filtration filters, such as those configured to remove impurities from water. Such filters can include one or more of the following features: an operating pressure range of 20-80 pounds per square inch, a rated capacity of 500 gallons, a maximum operating temperature of 90 degrees Fahrenheit, and a maximum flow rate of 0.4 gallons per minute. The filters of this disclosure can be coupled to and/or operate with the present filtration systems in any suitable way, including in the ways described in detail in pending patent application Ser. No. 14/160,498, which is incorporated by reference in its entirety. Other ways in which a filter can be coupled to and/or operate with the present filtrations systems are described in detail below.

Further, the present filtration systems, including filtration system 100 (and more specifically housing 104 of filtration unit 102), are configured to be coupled to a carbonation canister, such as carbonation canister 144, for example, in the embodiment shown in FIG. 8. Carbonation canisters, which can comprise fluid, such as CO₂, and in-line carbonation systems and apparatuses are described in detail by U.S. patent application Ser. No. 12/772,641 (Publication No. US 2011/0268845) and International Patent Application No. PCT/US2011/033709 (Publication No. WO/2011/139614), which are incorporated by reference in their entirety. Other ways in which carbonation and in-line carbonation systems can operate with the present filtrations systems are described in detail below.

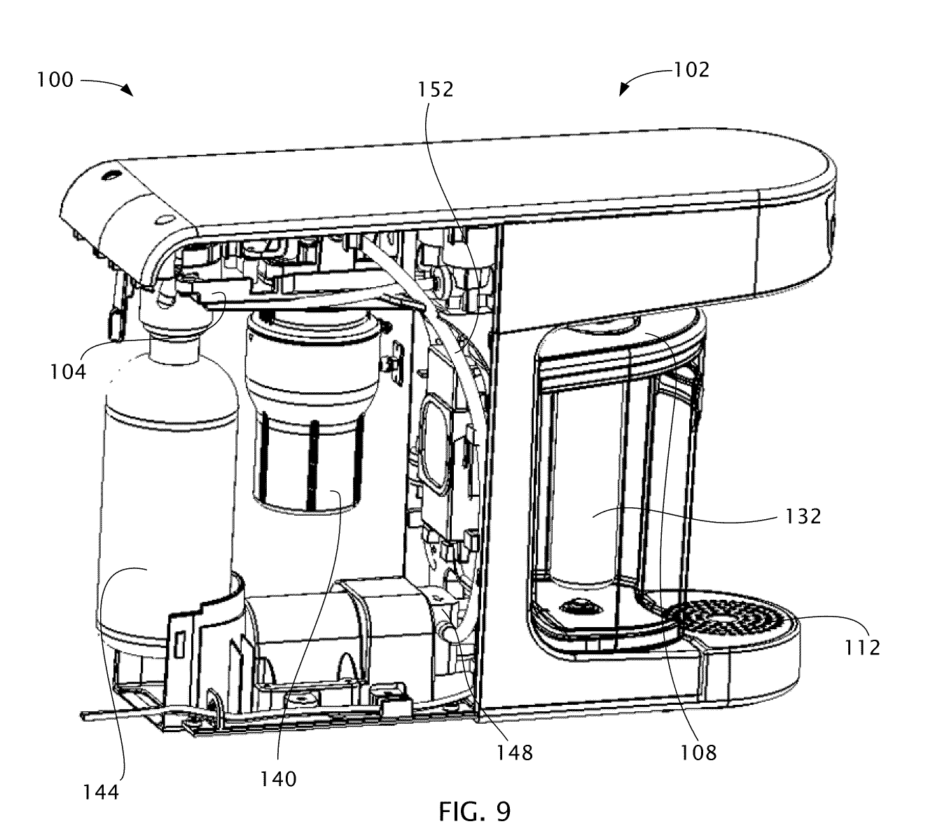

In the embodiment shown, filtration system 100 further comprises pump 148, as shown in FIG. 9, which is coupled to housing 104 of filtration unit 102. Pump 148 can be coupled to any suitable component of housing 104 of filtration unit 102, and in any suitable way, including by adhesives, screws, bolts, and the like. Tubing 128, which is coupled to dry break assembly 124, is also coupled to pump 128 to permit fluid to be pumped into other components of filtration system 100. Further, tubing 152 is also coupled to pump 148 and to filter 140 such that pump 148 and filter 140 (as well as dry break assembly 124) are in fluid communication.

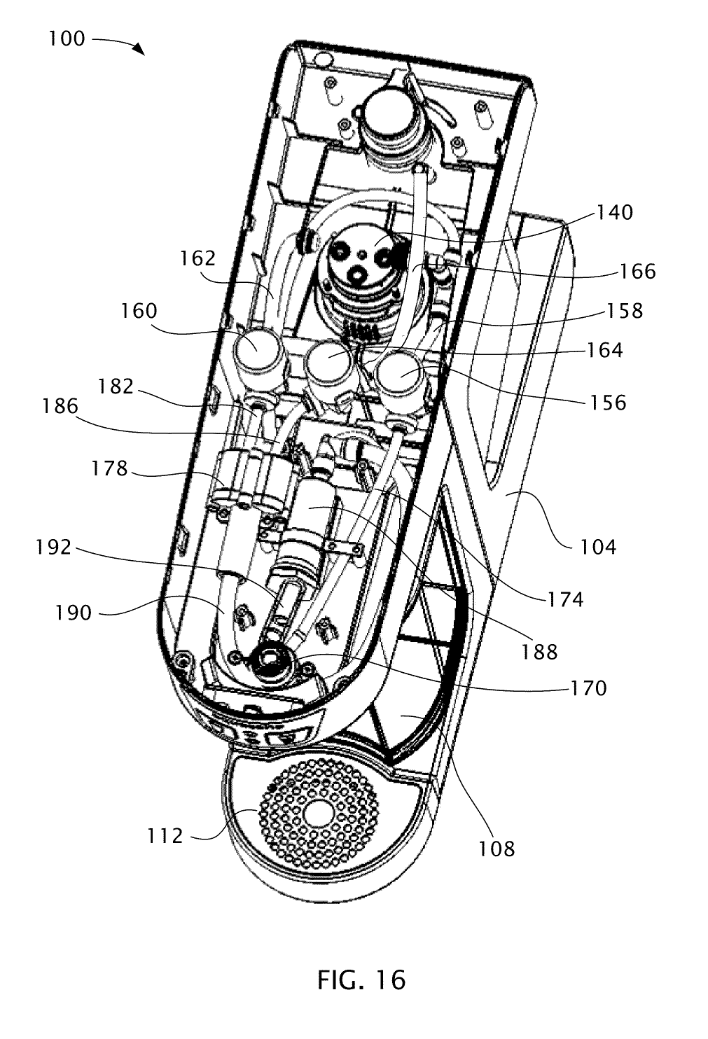

As shown in FIG. 16, filter 140 is coupled to solenoid 156 (e.g., via tubing 158) and solenoid 160 (e.g., via tubing 162). Carbonation canister 144 is coupled to solenoid 164 (e.g., via tubing 166). Solenoid 156 is further coupled to spout 170 (e.g., via tubing 174). Solenoid 160 is coupled to carbonator 178 (e.g., via tubing 182), and solenoid 164 is coupled to carbonator 178 (e.g., via tubing 186). Additionally, carbonator 178 is coupled to flow conditioner 188 (e.g., via tubing 190). Tubing 190 can comprise a conditioning insert that is configured to mix fluid from carbonator 178, which is discussed in detail below. Flow conditioner 188 is coupled to spout 170 (e.g., via tubing 192).

In the embodiment shown, a user can activate a first configuration or a second configuration, for example, by pressing first button 193 to activate a first configuration or by pressing second button 194 to activate a second configuration. In the embodiment shown, controller 195 is coupled (e.g., electrically) to pump 148, solenoid 156, and first button 193. If a user activates a first configuration by pressing first button 193 and if pitcher 108 comprises fluid and is coupled to filtration unit 102 (as depicted in FIG. 1), filtration system 100 (and, more specifically filtration unit 102) can filter fluid from pitcher 108 and dispense fluid from filtration unit 102 (e.g., through spout 170 of housing 104). More specifically, if a user activates a first configuration by pressing first button 193, controller 195 signals pump 148 to begin pumping fluid from pitcher 108, and controller 195 signals solenoid 156 to open. As pitcher 108 is coupled to filtration unit 102, valve 120 of pitcher 108 and dry break assembly 124 cooperate to permit fluid from the interior of pitcher 108 to enter filtration unit 102. Pump 148 pumps fluid through tubing 128, through tubing 152, and into filter 140, where fluid from pitcher 108 can be filtered. Filtered fluid exits filter 140 through tubing 158, passing through solenoid 156 (which was opened by controller 195), through tubing 174, and out of housing 104 of filtration unit 102 through spout 170.

If a user activates a second configuration by pressing second button 194 and if pitcher 108 comprises fluid and is coupled to filtration unit 102 (as depicted in FIG. 1), filtration system 100 (and, more specifically filtration unit 102) can filter fluid from pitcher 108, mix fluid from pitcher 108 with fluid from carbonation canister 144, and dispense fluid from filtration unit 102 (e.g., through spout 170 of housing 104). More specifically, if a user activates a second configuration by pressing second button 194, controller 195 signals pump 148 to begin pumping fluid from pitcher 108, and controller 195 signals solenoid 160 and solenoid 164 to open. As pitcher 108 is coupled to filtration unit 102, valve 120 of pitcher 108 and dry break assembly 124 cooperate to permit fluid from the interior of pitcher 108 to enter filtration unit 102. Pump 148 pumps fluid through tubing 128, through tubing 152, and into filter 140, where fluid from pitcher 108 can be filtered. Filtered fluid from pitcher 108 exits filter 140 through tubing 162, passing through solenoid 160 (which was opened by controller 195), through tubing 182 and into carbonator 178 to be mixed with fluid from carbonation canister 144. Fluid from carbonation canister passes through tubing 166, through solenoid 164 (which was opened by controller 195), through tubing 186, and into carbonator 178 to be mixed with filtered fluid from pitcher 108. After an initial mixing of filtered fluid from pitcher 108 and fluid from carbonation canister 144 in carbonator 178, mixed fluid passes through tubing 190, which, as stated above, can comprise a conditioning insert that encourages further mixing of filtered fluid from pitcher 108 and fluid from carbonation canister 144. Mixed fluid then passes into flow conditioner 188, which is configured, for example, to control fluid flow, fluid pressure, and fluid mixing. For example, before fluid exits filtration unit 102, filtration unit 102 (and, more specifically, flow conditioner 188) is configured such that fluid flow pressure is approximately 60 pounds per square inch (e.g., flow conditioner 188 is configured to maintain fluid pressure at approximately 60 pounds per square inch). In other embodiments, however, fluid flow can comprise more (e.g., 65, 70, 75 or more pounds per square inch) or less (e.g., 55, 50, 45, or less pounds per square inch) pressure before exiting filtration unit 102. Mixed fluid can then pass through tubing 192 and out of housing 104 of filtration unit 102 through spout 170.

In some embodiments, filtration system 100 can further comprise a sensor coupled (e.g., electrically) to controller 195 and configured to detect if fluid enters filtration unit 102 such that if a user activates a first configuration or a second configuration, controller 195 is configured to pump fluid from pitcher 108 after the sensor detects that fluid has entered filtration unit 102 (e.g., so that pump 148 does not activate if no fluid has entered filtration unit 102).

In some embodiments, filtration system 102 is configured to alert a user when filter 140 should be replaced. For example, filtration unit 102 can be configured to detect an amount of flow through filter 140 and/or through some component of filtration unit 102 to alert a user when filter 140 should be replaced. In some embodiments, filtration unit 102 can be configured to alert a user that a filter should be replaced based on a volume of flow through filter 140 and/or through some component of filtration unit 102. In some embodiments, filtration unit 102 can be configured to alert a user that a filter should be replaced based on an approximate time of usage. For example, a replacement indicator can be coupled to filtration unit 102, and the replacement indicator can be configured to alert a user when filter 140 should be replaced and/or when filter 140 has a given amount of usage remaining, such as, for example, by activating an LED or by changing a color of an LED. After the filter has been replaced, filtration unit 102 can be configured to automatically reset any volumetric and/or temporal tracking of the filter, and/or filtration unit 102 can be configured to permit a user to reset (e.g., by pressing a button) any volumetric and/or temporal tracking of the filter.

Designated as numeral 200 in FIGS. 17A-17B is another embodiment of the present filtrations systems. Filtration system 200 is similar in many respects to filtration system 100, and some identical or similar components and/or functionalities are described below for clarity. However, because of the numerous similarities between filtration system 100 and filtration system 200, the differences are primarily discussed below. Filtration system 200 can comprise any identical or similar components and/or functionalities as those described above with respect to filtration system 100 or below with respect to additional embodiments of filtration systems. For example, as depicted in FIGS. 17A-17B, filtration system 200 comprises housing 204 and pitcher 208 coupled to housing 204. Filtration system 200 further comprises carbonation canister compartment 296 configured to accommodate carbonation canister 244, and door 297 which is coupled (e.g., hingedly) to housing 204. Door 297 opens to permit a user to couple a carbonation canister to or decouple a carbonation canister from housing 204. Further, door 297 is configured to close to, for example, prevent visibility of carbonation canister 244 or to prevent a user from accessing carbonation canister 244.

Designated as numeral 300 in FIGS. 18A-18B is another embodiment of the present filtrations systems. Filtration system 300 is similar in many respects to filtration system 100 and filtration system 200, and some identical or similar components and/or functionalities are described below for clarity. However, because of the numerous similarities between filtration system 100, filtration system 200, and filtration system 300 the differences are primarily discussed below. Filtration system 300 can comprise any identical or similar components and/or functionalities as those described above with respect to filtration system 100 and filtration system 200, or below with respect to additional embodiments of filtration systems. For example, as depicted in FIGS. 18A-18B, filtration system 300 comprises housing 304 and pitcher 308 coupled to housing 304. Housing 304 further comprises drain 312, which can assist in preventing fluid from spilling onto areas surrounding filtration system 300. Further, filtration system 300 comprises first button 393 and second button 394, which are configured to permit a user to activate a first configuration and a second configuration as discussed in detail with respect to filtration system 100.

Designated as numeral 400 in FIGS. 19A-19D is another embodiment of the present filtrations systems. This embodiment is also shown in FIGS. 35-43, though the features have not been numbered in FIGS. 35-43. Filtration system 400 is similar in many respects to filtration system 100, filtration system 200, and filtration system 300, and some identical or similar components and/or functionalities are described below for clarity. However, because of the numerous similarities between filtration system 100, filtration system 200, filtration system 300, and filtration system 400 the differences are primarily discussed below. Filtration system 400 can comprise any identical or similar components and/or functionalities as those described above with respect to filtration system 100, filtration system 200, and filtration system 300, or below with respect to additional embodiments of filtration systems. For example, as depicted in FIGS. 19A-19D, filtration system 400 comprises housing 404 and pitcher 408 coupled to housing 404. Housing 404 further comprises drain 412, which can assist in preventing fluid from spilling onto areas surrounding filtration system 400. Further, filtration system 400 comprises first button 493 and second button 494, which are configured to permit a user to activate a first configuration and a second configuration as discussed in detail with respect to filtration system 100. Filtration system 400 further comprises carbonation canister adjuster 498, which is configured to permit a user to adjust an amount of fluid exiting the carbonation canister if a carbonation canister is coupled to the housing. In the embodiment shown, carbonation canister adjuster 498 comprises a bar with which a user can grip and rotate carbonation canister adjuster 498 to increase or decrease the amount of fluid exiting a carbonation canister (e.g., increasing or decreasing the carbonation of any fluid exiting housing 404 if a user activates the second configuration).

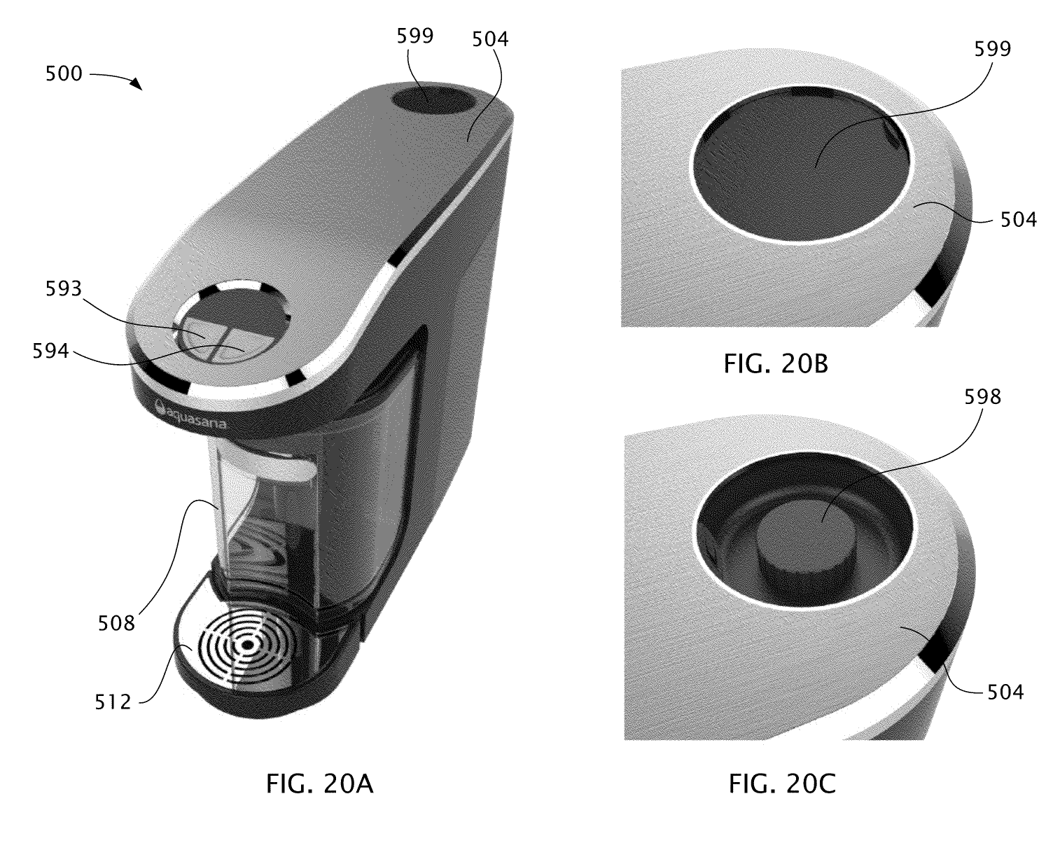

Designated as numeral 500 in FIGS. 20A-20C is another embodiment of the present filtrations systems. Filtration system 500 is similar in many respects to filtration system 100, filtration system 200, and filtration system 300, and filtration system 400, and some identical or similar components and/or functionalities are described below for clarity. However, because of the numerous similarities between filtration system 100, filtration system 200, filtration system 300, filtration system 400, and filtration system 500, the differences are primarily discussed below. Filtration system 500 can comprise any identical or similar components and/or functionalities as those described above with respect to filtration system 100, filtration system 200, filtration system 300, and filtration system 400, or below with respect to additional embodiments of filtration systems. For example, as depicted in FIGS. 20A-20C, filtration system 500 comprises housing 504 and pitcher 508 coupled to housing 504. Housing 504 further comprises drain 512, which can assist in preventing fluid from spilling onto areas surrounding filtration system 500. Further, filtration system 500 comprises first button 593 and second button 594, which are configured to permit a user to activate a first configuration and a second configuration as discussed in detail with respect to filtration system 100. Filtration system 500 further comprises carbonation canister adjuster 598, which is configured to permit a user to adjust an amount of fluid exiting the carbonation canister if a carbonation canister is coupled to the housing. In the embodiment shown, carbonation canister adjuster 598 comprises various grooves with which a user can grip and rotate carbonation canister adjuster 598 to increase or decrease the amount of fluid exiting a carbonation canister (e.g., increasing or decreasing the carbonation of any fluid exiting housing 504 if a user activates the second configuration). The embodiment shown in FIGS. 20A-20C further comprises carbonation canister adjuster guard 599, which is coupled (e.g., slidably) to housing 504 and can be moved to prevent or permit visibility of carbonation canister adjuster 598, or to prevent or permit access to carbonation canister adjuster 598.

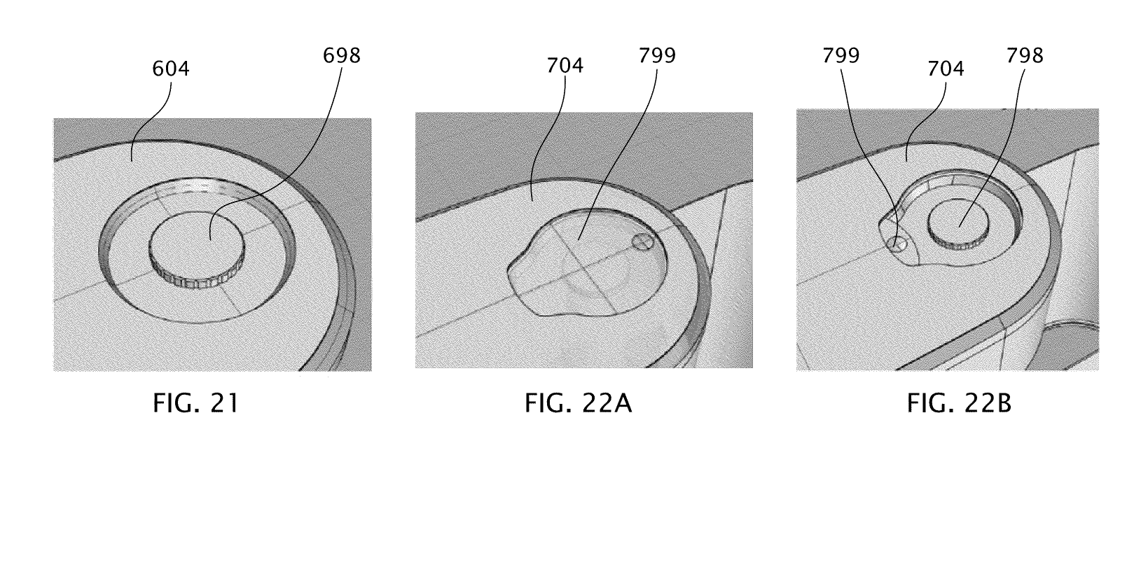

FIGS. 21-22B depict other embodiments of carbonation canister adjusters. As above, the filtration systems that comprise the carbonation canister adjusters in FIGS. 21-22B can comprise any identical or similar components and/or functionalities as those described above with respect to filtration system 100, filtration system 200, filtration system 300, filtration system 400, and filtration system 500. FIG. 21 depicts housing 604, which comprises carbonation canister adjuster 698. Carbonation canister adjust 698 is configured to permit a user to adjust an amount of fluid exiting the carbonation canister if a carbonation canister is coupled to the housing. In the embodiment shown, carbonation canister adjuster 698 comprises various grooves with which a user can grip and rotate carbonation canister adjuster 698 to increase or decrease the amount of fluid exiting a carbonation canister (e.g., increasing or decreasing the carbonation of any fluid exiting housing 604 if a user activates the second configuration). FIGS. 22A-22B depict housing 704, which comprises carbonation canister adjuster 798. Carbonation canister adjust 798 is configured to permit a user to adjust an amount of fluid exiting the carbonation canister if a carbonation canister is coupled to the housing. In the embodiment shown, carbonation canister adjuster 798 comprises various grooves with which a user can grip and rotate carbonation canister adjuster 798 to increase or decrease the amount of fluid exiting a carbonation canister (e.g., increasing or decreasing the carbonation of any fluid exiting housing 704 if a user activates the second configuration). The embodiment shown in FIGS. 22A-22B further comprises carbonation canister adjuster guard 799, which is coupled (e.g., slidably) to housing 704 and can be moved to prevent or permit visibility of carbonation canister adjuster 798, or to prevent or permit access to carbonation canister adjuster 798.

The present disclosure also includes methods of filtering fluid (e.g., such as tap water), such as those comprising coupling a pitcher (e.g., pitcher 108) holding fluid to a filtration unit (e.g., filtration unit 102); and activating the filtration unit in one of a first configuration in which fluid is pumped from the pitcher, through a filter (e.g., filter 140), and out of the filtration unit and a second configuration in which fluid is pumped from the pitcher, through a filter, through a carbonator (e.g., carbonator 178) to be carbonated, and out of the filtration unit. In some embodiments, activating the filtration unit comprises pressing one or more buttons (e.g., first button 193 and/or second button 194). Some embodiments of the present methods further comprise chilling fluid in the pitcher with a cooling stick (e.g., cooling stick 132).

Some embodiments of the present methods comprise engaging a pitcher (e.g., pitcher 108) holding fluid to a filtration unit (e.g., filtration unit 102); and activating the filtration unit in one of a first configuration in which fluid is pumped from the pitcher, through a filter (e.g., filter 140), and out of the filtration unit and a second configuration in which fluid is pumped from the pitcher, through a filter, through a carbonator (e.g., carbonator 178) to be carbonated, and out of the filtration unit. In some embodiments, activating the filtration unit comprises pressing one or more buttons (e.g., first button 193 and/or second button 194). Some embodiments of the present methods further comprise chilling fluid in the pitcher with a cooling stick (e.g., cooling stick 132).

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present systems, units, and methods are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted (e.g., threads may be substituted with press-fittings or welds). Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A filtration unit comprising:
a pump;
a carbonator; and
a housing coupled to the pump and the carbonator, the housing configured to be coupled to:
a filter;
a carbonation canister; and
a pitcher;
where, if the housing is coupled to a filter, a carbonation canister comprising fluid, and a pitcher comprising fluid, the filtration unit can:
pump fluid from the pitcher, through the filter, and out of the housing if a user activates a first configuration; and
pump fluid from the pitcher, through the filter, through the carbonator to be mixed with fluid from the carbonation canister, and out of the housing if a user activates a second configuration.

2. The filtration unit of claim 1, where the housing further comprises:
a dry break assembly configured to cooperate with a pitcher having an interior to permit fluid communication between the interior and the filtration unit.

3.-4. (canceled)

5. The filtration unit of claim 1, further comprising:
a controller configured to enable a user to activate the first configuration if a user presses a first button and to enable a user to activate the second configuration if a user presses a second button.

6. The filtration unit of claim 1, further comprising:
a controller; and
a sensor coupled to the controller and configured to detect if fluid enters the filtration unit;
where, if a user activates the first configuration or the second configuration, the controller is configured to pump fluid from a pitcher after the sensor detects that fluid has entered the filtration unit.

7. The filtration unit of claim 1, further comprising:
a controller;
a first solenoid;
a second solenoid; and
a third solenoid;
where the controller is configured such that:
if a user activates the first configuration, the controller signals to open the first solenoid to permit fluid from the pitcher to move out of the housing; and
if a user activates the second configuration, the controller signals to:
open the second solenoid to permit fluid from the pitcher to move into the carbonator; and
open the third solenoid to permit fluid from the carbonation canister to move into the carbonator.

8. The filtration unit of claim 1, further comprising:
a flow conditioner configured to control fluid flow after exiting the carbonator.

9.-13. (canceled)

14. The filtration unit of claim 1, further comprising:
a carbonation canister adjuster configured to permit a user to adjust an amount of fluid exiting the carbonation canister if the carbonation canister is coupled to the housing.

15. The filtration unit of claim 1, where the filtration unit is configured to alert a user when the filter, if coupled to the housing, should be replaced.

16. The filtration unit of claim 1, where the housing further comprises:
a carbonation canister compartment configured to accommodate a carbonation canister; and
a door configured to open to permit a user to couple a carbonation canister to or decouple a carbonation canister from the housing and configured to close to prevent visibility of the carbonation canister.

17. A filtration unit comprising:
a pump;
a carbonator; and
a housing coupled to the pump and the carbonator, the housing configured to be coupled to:
a filter;
a carbonation canister; and
a pitcher;
where, if the housing is coupled to a filter, a carbonation canister comprising fluid, and a pitcher comprising fluid, the filtration unit can:
filter fluid from the pitcher and dispense the fluid from the housing if a user activates a first configuration; and
filter fluid from the pitcher, mix fluid from the pitcher with fluid from the carbonation canister, and dispense fluid from the housing if a user activates a second configuration.

18. The filtration unit of claim 17, where the housing further comprises:
a dry break assembly configured to cooperate with a pitcher having an interior to permit fluid communication between the interior and the filtration unit.

19.-20. (canceled)

21. The filtration unit of claim 17, further comprising:
a controller configured to enable a user to activate the first configuration if a user presses a first button and to enable a user to activate the second configuration if a user presses a second button.

22. The filtration unit of claim 17, further comprising:
a controller; and
a sensor coupled to the controller and configured to detect if fluid enters the filtration unit;
where, if a user activates the first configuration or the second configuration, the controller is configured to pump fluid from a pitcher after the sensor detects that fluid has entered the filtration unit.

23. (canceled)

24. The filtration unit of claim 17, further comprising:
a flow conditioner configured to control fluid flow after exiting the carbonator.

25.-29. (canceled)

30. The filtration unit of claim 17, further comprising:
a carbonation canister adjuster configured to permit a user to adjust an amount of fluid exiting the carbonation canister if the carbonation canister is coupled to the housing.

31. The filtration unit of claim 17, where the filtration unit is configured to alert a user when the filter, if coupled to the housing, should be replaced.

32. (canceled)

33. A filtration system comprising:
a pitcher;
a filter;
a carbonation canister; and
a filtration unit coupled to the pitcher, the filter, and the carbonation canister, the filtration unit comprising:
a pump; and
a carbonator;
where, if the carbonation canister comprises fluid and the pitcher comprises fluid, the filtration system can:
filter fluid from the pitcher and dispense the fluid from the housing if a user activates a first configuration; and
filter fluid from the pitcher, mix fluid from the pitcher with fluid from the carbonation canister, and dispense fluid from the housing if a user activates a second configuration.

34.-35. (canceled)

36. The filtration unit of claim 33, further comprising:
a controller configured to enable a user to activate the first configuration if a user presses a first button and to enable a user to activate the second configuration if a user presses a second button.

37.-43. (canceled)

44. The filtration unit of claim 33, where the pitcher is coupled to a cooling stick configured to cool fluid in the pitcher.

45.-46. (canceled)

47. The filtration unit of claim 33, where the housing further comprises:
a carbonation canister compartment configured to accommodate the carbonation canister; and
a door configured to open to permit a user to couple the carbonation canister to or decouple the carbonation canister from the housing and configured to close to prevent visibility of the carbonation canister.

48. A method of filtering fluid, comprising:
coupling a pitcher holding fluid to a filtration unit; and
activating the filtration unit in one of:
a first configuration in which fluid is pumped from the pitcher, through a filter, and out of the filtration unit; and
a second configuration in which fluid is pumped from the pitcher, through a filter, through a carbonator to be carbonated, and out of the filtration unit.

49. (canceled)

50. The method of claim 48, further comprising:
chilling fluid in the pitcher with a cooling stick.

51. A method of filtering fluid, comprising:
engaging a pitcher holding fluid with a filtration unit; and
activating the filtration unit in one of:
a first configuration in which fluid is pumped from the pitcher, through a filter, and out of the filtration unit; and
a second configuration in which fluid is pumped from the pitcher, through a filter, through a carbonator to be carbonated, and out of the filtration unit.

52. (canceled)

53. The method of claim 51, further comprising:
chilling fluid in the pitcher with a cooling stick.
